(19) United States
(12) Patent Application Publication
(10) Pub. No.: US 2026/0066325 A1
(43) Pub. Date: Mar. 5, 2026

(54) ELECTROLYZER FOR SPONTANEOUSLY GENERATING HYDROGEN AND A METHOD FOR IMPLEMENTING SAME

(71) Applicant: BST Systems, Inc., Plainfield, CT (US)

(72) Inventors: Bryan D. Hirschorn, Pawcatuck, CT (US); Michael A. Solis, Colchester, CT (US)

(21) Appl. No.: 19/382,731

(22) Filed: Nov. 7, 2025

Related U.S. Application Data
(63) Continuation-in-part of application No. 17/876,831, filed on Jul. 29, 2022, now Pat. No. 12,492,481.
(60) Provisional application No. 63/270,251, filed on Oct. 21, 2021.

(51) Int. Cl. H01M 8/18; C25B 9/63; C25B 9/65; C25B 9/70; C25B 11/02; C25B 11/031; C25B 11/042; C25B 15/08; H01M 4/86; H01M 4/90

(52) U.S. Cl. CPC H01M 8/188; C25B 9/63; C25B 9/65; C25B 9/70; C25B 11/02; C25B 11/031; C25B 11/042; C25B 15/08; H01M 4/8615; H01M 4/9041

(57) ABSTRACT

A negative electrode assembly may include a negative electrode formed in a substantially plate-shaped form. The negative electrode may include a first surface and a first edge adjacent the first surface. The assembly may further include an insulating material enclosing the first edge. A zinc hydrogen cell may include a cell case defining a cell interior, negative electrodes and positive electrodes provided within the cell interior, a negative terminal in electrical communication with the negative electrodes, a positive terminal in electrical communication with the positive electrodes; and an aqueous electrolyte comprising a reversible electro-active material disposed within the cell case. The negative electrodes and positive electrodes may be arranged in an alternating configuration with a gap between adjacent electrodes. Each negative electrode may be substantially plate-shaped and include a first surface and a first edge. The first edge may be enclosed within an insulating material.

### CROSS-REFERENCE TO RELATED APPLICATIONS

This application is a continuation-in-part of U.S. patent application Ser. No. 17/876,831 filed Jul. 29, 2022, which claims priority to U.S. Provisional Patent Application No. 63/270,251 filed Oct. 21, 2021, the contents of each of which are incorporated herein by reference.

### BACKGROUND OF THE INVENTION

Hydrogen is a clean and potentially renewable fuel source having a specific energy density which is approximately equal to 33.3 kWh of usable energy per kilogram (kg) (33.3 kwh/kg H2 theoretical lower heating value). However, the implementation of Hydrogen as a renewable energy source may be limited by both technical and economic challenges associated with its generation, compression, storage and delivery. The two most common methods for generating hydrogen are “steam-methane reforming” and “electrolysis” which differ based on the source from which the hydrogen is being generated. The steam-methane reforming method is a method for producing hydrogen from natural gas which is mostly methane. This method typically emits Carbon Dioxide (CO2) into the atmosphere, which is undesirable, and therefore, is typically referred to as “grey hydrogen.” The electrolysis method produces hydrogen without the use of fossil fuels and involves the process of ‘water splitting.’ In the electrolysis method electricity is used to split the water molecules into hydrogen and oxygen gas. Hydrogen generated in this manner (i.e., generated from a renewable and carbon-free energy source such as solar, wind, nuclear and hydro) is typically referred to as “green hydrogen.”

Currently, the electrolysis method may be accomplished by electrolyzers, such as Polymer Electrolyte Membrane (PEM) Electrolyzers, Anion Exchange Membrane (AEM) Electrolyzers, Alkaline Electrolyzers (AE), and Solid Oxide (SO) Electrolyzers, which split water in a single step. Accordingly, input energy is required during the hydrogen generation phase to cause the water molecules to split. This coupling of energy input and hydrogen production may create several operational and economic disadvantages. If the generated hydrogen is to be used at a later time, such as for fuel for heat or power, then compression and storage of the hydrogen will be required. Unfortunately, however, mechanical and/or electrochemical compression of the hydrogen is expensive, having a Capital Expense (CapEx) which is typically in the range of $20,000 to $100,000 per kg H₂/hour depending upon the type, scale and desired output pressure. Moreover, storage of the hydrogen is also expensive, having a Capital Expense (CapEx) which is typically in the range of $1,000 to $3,000 per kg H2. Furthermore, conventional electrolyzers, such as PEMs, AEMs, AEs and SOs typically require precious platinum group metal catalysts, organic based membranes that are prone to degradation (for example, such as Nafion), and a complicated, material and labor intensive bi-polar design, all of which are very expensive, having a typical CapEx of approximately $100,000-$300,000 per kg H₂/hour. All of this is undesirable because it increases cost for producing and operating systems that use hydrogen as a renewable fuel source.

Zinc hydrogen battery systems (ZHBs), also known as Spontaneous Electrolyzers, represent a fundamentally different approach to hydrogen generation that addresses many of these limitations. A ZHB decouples energy storage from hydrogen generation by storing electrical energy through the conversion of zincate (zinc-ion) to metallic zinc during a charging phase, then later releasing this stored energy to spontaneously electrolyze water and generate hydrogen gas on demand without requiring external electrical input during the discharge phase, thus storing hydrogen energy without the need for costly compressors or storage tanks.

However, zinc-based electrochemical systems have historically suffered from limited cycle life due to inherent challenges associated with zinc electrochemistry. The primary technical challenge is the formation of dendritic zinc structures during the charging process. Dendritic zinc formation can lead to several detrimental effects including: (1) electrical shorts when dendrites bridge between positive and negative electrodes, (2) high self-discharge rates resulting in poor round-trip efficiency, (3) reduced charge capacity, and (4) poor cyclic capacity retention due to loss of active zinc material over repeated charge-discharge cycles.

Accordingly, it may be desirable to develop methods and systems that can optimize ZHB performance through the elimination, minimization, and detection of detrimental dendritic zinc growth during charging operations.

### SUMMARY OF THE INVENTION

At least an exemplary embodiment of a negative electrode assembly for use in a zinc hydrogen cell may include a negative electrode formed in a substantially plate-shaped form. The negative electrode may include a first surface and a first edge adjacent the first surface. The negative electrode assembly may further include an insulating material enclosing the first edge.

At least an exemplary embodiment of a zinc hydrogen cell may include a cell case defining a cell interior, a plurality of negative electrodes provided within the cell interior, a plurality of positive electrodes provided within the cell interior, a negative terminal in electrical communication with the plurality of negative electrodes, a positive terminal in electrical communication with the plurality of positive electrodes, and an aqueous electrolyte comprising a reversible electro-active material disposed within the cell case. The plurality of negative electrodes and the plurality of positive electrodes may be arranged in an alternating configuration with a gap between adjacent electrodes. Each negative electrode of the plurality of negative electrodes may be formed in a substantially plate-shaped form and include a first surface a first edge adjacent to the first surface. The first edge may be enclosed within an insulating material.

At least an exemplary embodiment of a zinc hydrogen battery system may include a plurality of zinc hydrogen cells. Each zinc hydrogen cell of the plurality of zinc hydrogen cells may include a cell case defining a cell interior, a plurality of negative electrodes provided within the cell interior, a plurality of positive electrodes provided within the cell interior, a negative terminal in electrical communication with the plurality of negative electrodes, a positive terminal in electrical communication with the plurality of positive electrodes, an aqueous electrolyte comprising a reversible electro-active material disposed within the cell case, an electrolyte port provided at a bottom of the cell case, and a gas vent port provided at a top of the cell case. The plurality of negative electrodes and the plurality of positive electrodes may be arranged in an alternating configuration with a gap between adjacent electrodes. Each negative electrode of the plurality of negative electrodes may be formed in a substantially plate-shaped form and include a first surface and a first edge adjacent to the first surface. The first edge may be enclosed within an insulating material. The zinc hydrogen battery system may further include a first manifold coupled to each electrolyte port of the plurality of zinc hydrogen cells, a second manifold coupled to each gas vent port of the plurality of zinc hydrogen cells, an electrolyte storage in fluid communication with the first manifold and the second manifold, and a pump configured to circulate the aqueous electrolyte from the electrolyte storage, through the first manifold, through each zinc hydrogen cell of the plurality of zinc hydrogen cells, through the second manifold, and returning to the electrolyte storage.

At least an embodiment of a method of charging a zinc hydrogen cell may include providing a zinc hydrogen cell and applying an applied current density that satisfied the equation i>0.42c+0.068, where i is the applied current density in amps/inch² and c is a concentration of zincate in an aqueous electrolyte by weight percent. The zinc hydrogen cell may include a cell case defining a cell interior, a plurality of negative electrodes provided within the cell interior, a plurality of positive electrodes provided within the cell interior, a negative terminal in electrical communication with the plurality of negative electrodes, a positive terminal in electrical communication with the plurality of positive electrodes, and the aqueous electrolyte comprising a reversible electro-active material disposed within the cell case. The plurality of negative electrodes and the plurality of positive electrodes may be arranged in an alternating configuration with a gap between adjacent electrodes. Each negative electrode of the plurality of negative electrodes may be formed in a substantially plate-shaped form and may include a first surface and a first edge adjacent to the first surface. The first edge may be enclosed within an insulating material.

At least an exemplary embodiment of a method of terminating a charge process of a zinc hydrogen cell, may include providing a zinc hydrogen cell, measuring a cell voltage of the zinc hydrogen cell, calculating an exponential running average (ERA) of the cell voltage, calculating a difference between the measured cell voltage and the ERA of the cell voltage, comparing the difference to a predetermined voltage threshold, and, in response to the difference being less than or equal to the predetermined threshold voltage, returning to the step of measuring the cell voltage. The method may further include, in response to the difference being greater than a predetermined voltage threshold, incrementing an occurrence count, comparing the occurrence count to a predetermined occurrence threshold, in response to the occurrence count being less than or equal to the predetermined occurrence threshold, returning to the step of measuring the cell voltage, and in response to the occurrence count being greater than the predetermined occurrence threshold, terminating the charge process of the zinc hydrogen cell. The zinc hydrogen cell may include a cell case defining a cell interior, a plurality of negative electrodes provided within the cell interior, a plurality of positive electrodes provided within the cell interior, a negative terminal in electrical communication with the plurality of negative electrodes, a positive terminal in electrical communication with the plurality of positive electrodes, and the aqueous electrolyte comprising a reversible electro-active material disposed within the cell case. The plurality of negative electrodes and the plurality of positive electrodes may be arranged in an alternating configuration with a gap between adjacent electrodes. Each negative electrode of the plurality of negative electrodes may be formed in a substantially plate-shaped form and may include a first surface and a first edge adjacent to the first surface. The first edge may be enclosed within an insulating material.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1A illustrates a side transparent view of an Electrolyzer Cell configured for spontaneous electrolysis, in accordance with one embodiment of the invention.

FIG. 1B illustrates an exploded side transparent view of an Electrolyzer Cell configured for spontaneous electrolysis, in accordance with another embodiment of the invention.

FIG. 1C illustrates a side transparent view of the Electrolyzer Cell of FIG. 1B.

FIG. 2 illustrates a front side view of a Spontaneous Electrolyzer Cell System (SECS) which includes a plurality of the Electrolyzer Cells of FIG. 1A or FIG. 1B, in accordance with one embodiment of the invention.

FIG. 3 illustrates a side view of a ‘maintenance system’ for the Electrolyzer Cell of FIG. 1A and FIG. 1B and for the SECS of FIG. 3, in accordance with one embodiment of the invention.

FIG. 4 illustrates a side view of a ‘maintenance system’ for the Electrolyzer Cell of FIG. 1A and FIG. 1B and for the SECS of FIG. 3, in accordance with another embodiment of the invention.

FIG. 5 shows an operational block diagram illustrating a method for implementing and maintaining the Electrolyzer Cell of FIG. 1A, FIG. 1B, FIG. 1C and FIG. 2, in accordance with one embodiment of the invention.

FIG. 6 shows an operational block diagram illustrating a method for reducing/preventing a dendritic zinc short circuit in the Electrolyzer Cell of FIG. 1A, FIG. 1B, FIG. 1C and FIG. 2, in accordance with one embodiment of the invention.

FIG. 7 illustrates an operational block diagram of a Spontaneous Electrolyzer System (SES) having the Electrolyzer Cell of FIG. 1A, FIG. 1B, FIG. 1C and FIG. 2 integrated with a compressor, in accordance with one embodiment of the invention.

FIG. 8 shows an operational block diagram illustrating a method for generating, compressing and storing hydrogen gas using the Spontaneous Electrolyzer System (SES) having at least one Electrolyzer Cell (or SECS) integrated with at least one compressor, in accordance with one embodiment of the invention.

FIG. 9A shows a perspective cutaway view of a zinc hydrogen cell according to an exemplary embodiment.

FIG. 9B shows a perspective cutaway view of a zinc hydrogen cell with a second electrode frame made translucent to show electrode spacing according to an exemplary embodiment.

FIG. 9C shows a side view of a zinc hydrogen cell with a second electrode frame made translucent to show electrode spacing according to an exemplary embodiment.

FIG. 9D shows a perspective view of a first electrode frame according to an exemplary embodiment.

FIG. 9E shows a negative electrode according to an exemplary embodiment.

FIG. 9F shows a negative electrode assembly according to an exemplary embodiment.

FIG. 10A shows a cross-section of a negative electrode assembly according to an exemplary embodiment.

FIG. 10B shows a cross-section of a negative electrode assembly according to an exemplary embodiment.

FIG. 11 shows a perspective view of a zinc hydrogen battery system according to an exemplary embodiment.

FIG. 12 shows a flowchart of a method for terminating charge of a zinc hydrogen cell according to an exemplary embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various exemplary embodiments. Each example is provided by way of explanation and is not meant as a limitation and does not constitute a definition of all possible embodiments. It is understood that reference to a particular “exemplary embodiment” of, e.g., a structure, assembly, component, configuration, method, etc. includes exemplary embodiments of, e.g., the associated features, subcomponents, method steps, etc. forming a part of the “exemplary embodiment.”

For purposes of this disclosure, the phrases “devices,” “systems,” and “methods” may be used either individually or in any combination referring without limitation to disclosed components, grouping, arrangements, steps, functions, or processes.

It should be appreciated that the present disclosure describes at least one embodiment of a unique and novel device and method that spontaneously electrolyzes water to generate hydrogen thereby eliminating the requirement for compressing and storing the hydrogen, wherein as used herein, a ‘spontaneous’ process is a process that once started, continues on its own without any additional input energy. It should be appreciated that at least one embodiment is disclosed herein with regards to zinc being used as the electro-chemical material that acts as a reversible, electro-active material. This is because zinc has a high enough “half-cell” voltage (potential) that can drive the electrolysis (water splitting) hydrogen generation reaction “spontaneously” (without requiring external input energy). Additionally, “zinc-ion” in solution is used because by reversibly going between “plated zinc metal” (charged state) and “zinc-ion” in solution (discharged state) an “energy storage device” with an “infinite” cycle life is generated. It should be appreciated that, in one embodiment, conducting a post discharge procedure (as discussed hereinafter) and periodically introducing new electrolyte into the Electrolyzer Cell helps to allow for the unique and novel characteristic.

It should be further appreciated that although at least one embodiment is being disclosed herein with regards to zinc being the “reversible electro-active material”, other embodiments of the may be implemented using any “reversible electro-active material” that changes its state (i.e., chemical structure) when it is charged (i.e., converted to its reduced chemical state) and/or discharged (i.e., converted to its oxidized chemical state). For example, when a voltage (that causes an electric current to flow) is applied to an electrode at least partially comprised of this reversible electro-active material within an electrochemical system, suitable to the desired end purpose. To clarify, reduction occurs when a reactant gains electrons during reaction, and oxidation occurs when a reactant loses electrons during reaction. The corresponding oxidation and reduction reactions occur as a result of the applied voltage and corresponding transfer of electrons when an electric current flows as a result of an applied voltage in an electrochemical system. The electrochemical system may have a positive electrode, a negative electrode, and an electrolyte, wherein the negative electrode may be partially and/or wholly constructed of this “reversible electro-active material”, and the positive electrode may be partially and/or wholly constructed of a material that can catalyze the electrochemical formation of hydrogen and oxygen gas from an aqueous electrolyte. The reduction of this reversible electro-active material (at the negative electrode) occurs during a “charge” process and the oxidation of this reversible electro-active material (at the negative electrode) occurs during a “discharge” process. Correspondingly, during these processes, the generation of oxygen gas occurs during the “charge” process (at the positive electrode) and the generation of hydrogen gas occurs during the “discharge” process (at the positive electrode). Such materials, that have been defined herein as a “reversible electro-active material” may include “zinc-ion” (in solution) converting to “zinc metal” or zinc-oxide (solid) converting to zinc metal (solid). Accordingly, any reversible, electro-active material that has a sufficiently high “half-cell” potential (voltage) in its reduced state to either fully or partially drive the “electrolysis of water” reaction to generate hydrogen gas may be used, such as, for example, one or more of Zinc/Zinc-oxide (including all oxides of zinc in solid and soluble form in electrolyte); Pb/Pb oxide (including all oxides of pb in solid and soluble form in electrolyte); Fe/Fe oxide (including all oxides of iron in solid and soluble form in electrolyte); Cd/Cd oxide (including all oxides of cadmium in solid and soluble form in electrolyte); Metal Hydrides (for example, of the AB5 or AB2 type mischmetals); Vanadium and its ions and/or Sodium and its ions.

Accordingly, in at least one embodiment the spontaneous device is an electrolyzer that electrolyzes water in two steps. The first step involves introducing electricity into the device, wherein the electrical energy is stored by converting the electrical energy into chemical energy via a reversible, electro-active material, in this case zincate, to zinc metal and concurrently generating oxygen gas which is vented out of the device. The second step involves generating hydrogen gas via “spontaneous electrolysis,” wherein the chemical energy stored within the zinc metal is released when it is converted to zincate, thereby providing electrical energy required for electrolyzing the water to produce hydrogen as needed for immediate use. This device and method advantageously allows electrical energy to be introduced and stored within the electrolyzer during an off-peak period when electricity is inexpensive and mostly renewable or charged directly with renewable power. The device can then be discharged as desired (i. e., such as during an on-peak electricity period) thereby generating spontaneous, on-demand hydrogen that can be delivered to a burner (boiler or furnace) for heat, a turbine or engine for combined heat and power, fuel cell for power, and/or as a chemical feedstock, such as a reducing agent for clean steel production.

It should be appreciated that the unique feature of spontaneous hydrogen generation advantageously allows for hydrogen to be generated as desired and burned or oxidized at “time-of-generation”, thereby eliminating the requirement of compression and storage. It is important to note that conventional electrolyzers require input energy during the hydrogen generation phase to generate hydrogen. Therefore, from an energy perspective, the hydrogen generated from “conventional electrolysis” requires compression and storage prior to use because burning/oxidizing hydrogen at “time of generation” from a conventional electrolyzer is energetically counterproductive, i.e., more energy is required to split the water than is delivered in the form of heat or power during the burning/oxidation process. In the at least an exemplary embodiment, zincate, which is a reversible, electro-active material, is used to store energy for later use. However, conventionally, the inherent properties of zinc pose technical challenges that have historically limited the life of zinc-based electrochemical energy storage devices. These properties include the solubility and precipitation, solidification, and accumulation of zinc particles in electrolyte which is an inevitable consequence of the reduction and oxidation of zinc during the charge and discharge process, respectively.

Additionally, the precipitation/solidification process of zinc results in the loss of “electro-active material” and thus, the loss of delivered hydrogen capacity with each cycle. Moreover, another inherent property that limits the life of zinc-based electrochemical device involves the dendritic growth of zinc during charge which can cause an electric short if the dendrite physically bridges from the negative electrode to the positive electrode. It should be appreciated that uncontrolled dendritic growth is undesirable because if the electrolyzer experiences a dendritic short, a ‘self-discharge’ may occur resulting in a premature and uncontrolled release of hydrogen gas during and following the charge step. It should be further appreciated that one or more embodiments addresses these challenges.

In accordance with at least an embodiment, the invention described herein provides an Electrolyzer Cell and method for spontaneously and controllably generating hydrogen gas. Furthermore, in accordance with at least an embodiment, the invention provides an article and method for implementing and enabling the Electrolyzer Cell to have a long cycle life.

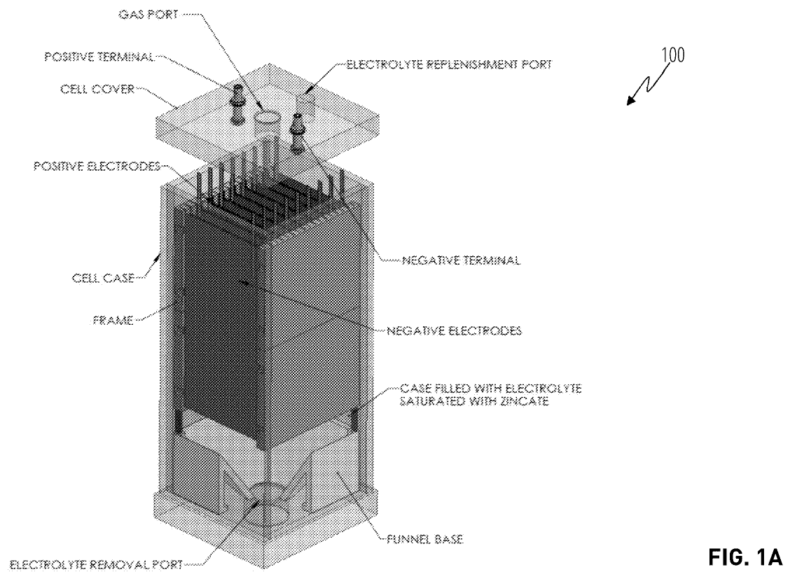

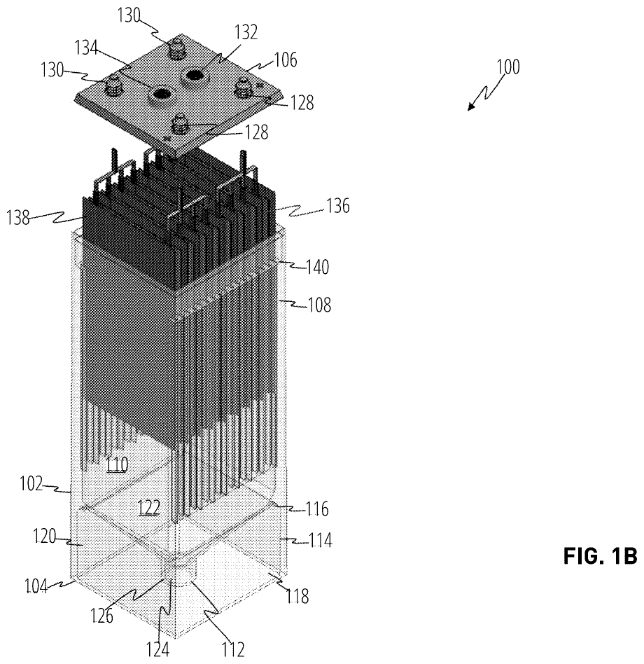

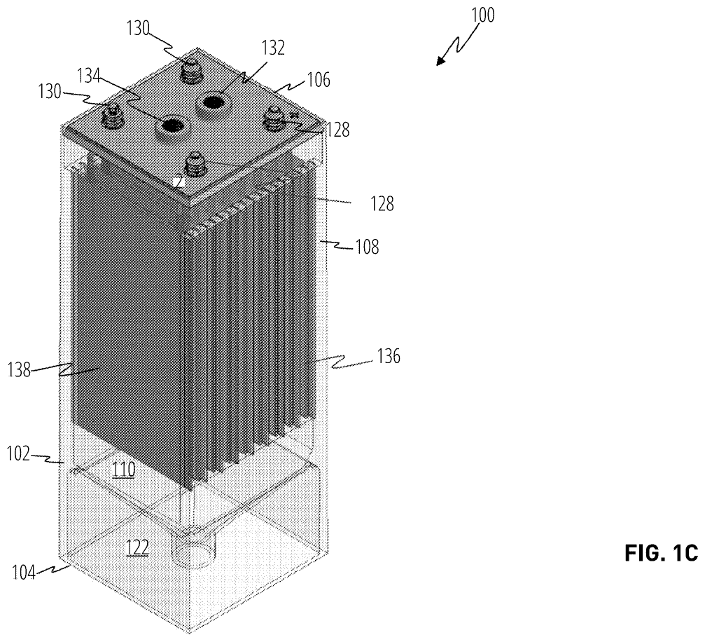

Referring to FIG. 1A, FIG. 1B and FIG. 1C, an Electrolyzer Cell 100 is shown in accordance with at least one embodiment, wherein the Electrolyzer Cell 100 is configured to spontaneously electrolyze an electrolyte solution to generate hydrogen. The Electrolyzer Cell 100 includes a cell case 102 having a case bottom 104, a case top 106 and case sides 108, wherein the case bottom 104, case top 106 and case sides 108 define a cell cavity 110. It should be appreciated that the cell cavity 110 of the Electrolyzer Cell 100 may be configured to contain approximately four (4) gallons of electrolyte. However, the Electrolyzer Cell 100 may be configured to have any capacity as desired suitable to the desired end purpose. The Electrolyzer Cell 100 further defines an electrolyte removal port 112 and includes a cell base 114, wherein the cell base 114 includes a base top 116, a base bottom 118 and base side walls 120 which define an angled shaped (such as a funnel, triangle, or bowl shaped) base cavity 122. It should be appreciated that the base bottom 118 defines a base bottom opening 124 which is communicated with the electrolyte removal port 112, wherein the electrolyte removal port 112 includes a port cover 126 which is removably configured to cover electrolyte removal port 112 to allow any precipitated zinc to be removed and/or electrolyte to be removed. The case top 106 includes one or more positive terminals 128, one or more negative terminals 130 an electrolyte replenishment port 132 and a gas port 134, wherein the gas port 134 is configured to allow gases that build up inside the cell cavity 110 to vent out. The Electrolyzer Cell 100 includes a plurality of positive electrodes 136 and a plurality of negative electrodes 138 which are held in place via a case frame 140, wherein the plurality of positive electrodes 136 and plurality of negative electrodes 138 are configured apart from each other so as not to directly contact each other. It should be appreciated that the cell cavity 110 is filled with an electrolyte solution which is saturated with Zincate.

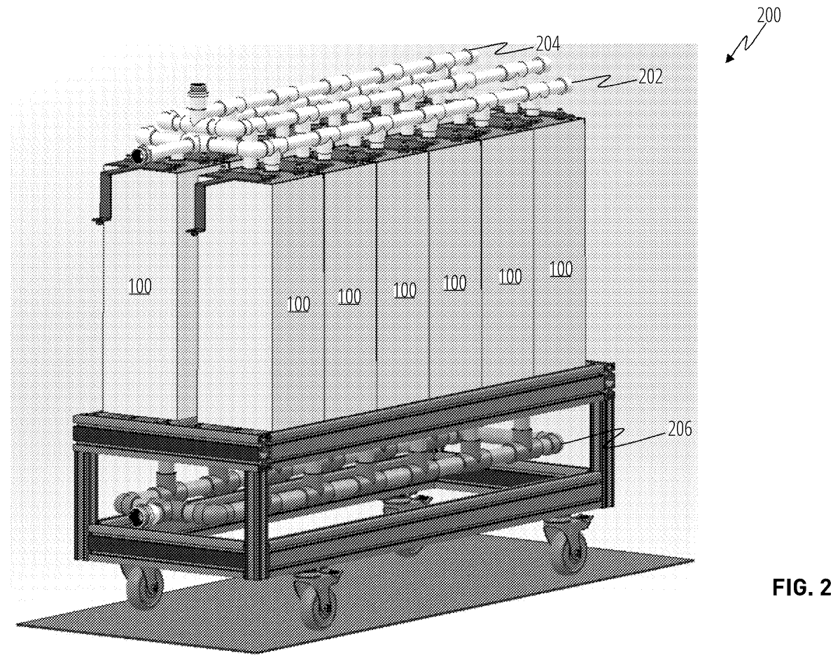

Referring to FIG. 2, it should be appreciated that the Electrolyzer Cell 100 may be connected to other Electrolyzer Cells 100 in a series and/or parallel configuration to form a Spontaneous Electrolyzer Cell System (SECS) 200 or module of Spontaneous Electrolyzer Cells 100. The Electrolyzer Cells 100 may be connected in series or parallel via the positive terminals 128 and negative terminals 130 of each of the Electrolyzer Cells 100 via an “inter-cell” connector which may be constructed of an electrically conductive material, such as copper. Moreover, the electrolyte replenishment ports 134, the electrolyte removal ports 112, and the gas ports 132 of each of the Electrolyzer Cells 100 may be connected to each other via a manifold plumbing system, respectively.

Additionally, the Electrolyzer Cell(s) 100 may be connected via their positive terminal 128 and their negative terminals 130 to a power supply during charge to store electrical energy and may be connected to a load or an electric conductor during discharge to spontaneously generate hydrogen gas. As shown in FIG. 2 and as discussed hereinabove, a plurality of the Electrolyzer Cells 100 may be grouped together to form the Spontaneous Electrolyzer Cell System (SECS) 200. In this embodiment, the Spontaneous Electrolyzer Cell System (SECS) 200 is shown having twelve (12) Electrolyzer Cells 100. It should be appreciated that in one or more embodiments, the Spontaneous Electrolyzer Cell System (SECS) 200 may include one or more of electrolyte replenishment tubing 202, gas venting tubing 204 and electrolyte removal tubing 206, wherein the electrolyte replenishment tubing 202 is in flow communication with the electrolyte replenishment ports 132 of each of the Electrolyzer Cells 100, the gas venting tubing 204 is in flow communication with the gas venting ports 134 of each of the Electrolyzer Cells 100 and the electrolyte removal tubing 206 is in flow communication with the electrolyte removal ports 112 of each of the Electrolyzer Cells 100.

This configuration advantageously allows each of the Electrolyzer Cells 100 to have the electrolyte contained therein to be replenished via the electrolyte replenishment tubing 202, the gas generated within each of the Electrolyzer Cells 100 to be vented via the gas venting ports 204 and the depleted electrolyte (and any dendritic material) to be removed via the electrolyte removal tubing 206. It is contemplated that, in one or more embodiments, the Spontaneous Electrolyzer Cell System (SECS) 200 may include one or more controllable flow valves to control the flow of electrolyte into and/or depleted electrolyte (and/or gas) out of each of the Electrolyzer Cells 100.

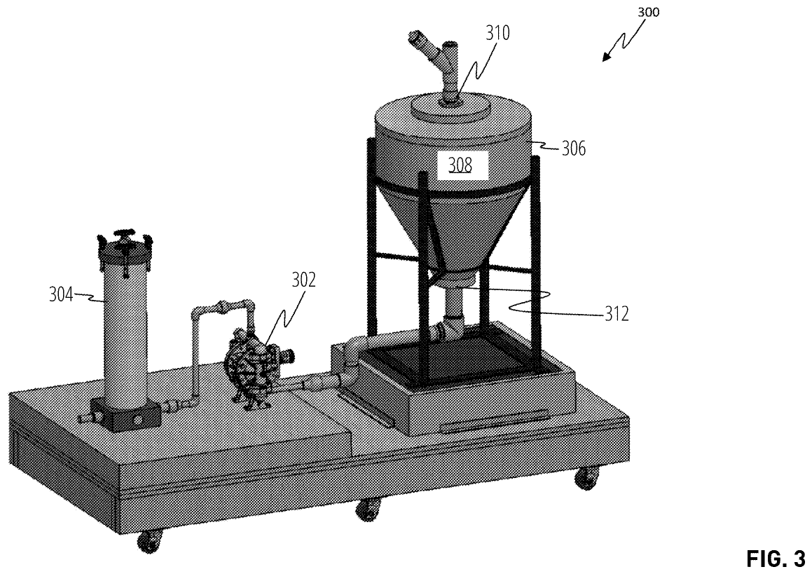

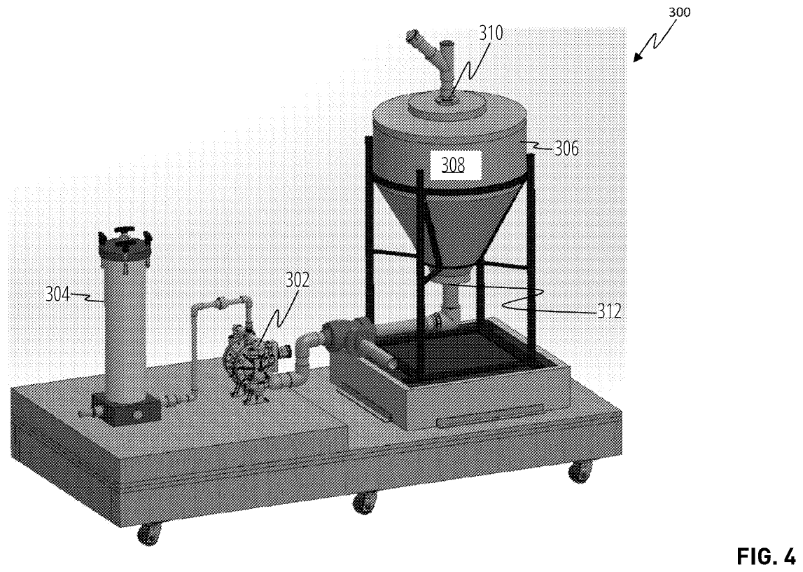

Referring to FIG. 3, it should be further appreciated that in other embodiments of the invention, the SECS 200 may be connected to a “maintenance system” 300 which may include a pump (302), a filter (304), and/or an electrolyte hopper (306), wherein the pump (302) may act to mechanically remove electrolyte and other particulates (i.e., dendritic material) from the cell cavities 110, the filter (304) may act to remove particulates from the aqueous electrolyte, and the electrolyte hopper (306) may contain fresh electrolyte and may act to replenish the fresh electrolyte to the cell cavities 110 of the Electrolyzer Cells 100.

In one embodiment, the electrolyte hopper (306) may define a hopper cavity (308) for containing fresh aqueous electrolyte, a first hopper port (310) for replenishing the hopper cavity (308) with the fresh aqueous electrolyte, a second hopper port (312) for adding zinc oxide to the fresh aqueous electrolyte, wherein the zinc oxide dissolves into soluble zincate in the alkaline aqueous electrolyte such that a stable and fully saturated electrolyte can be maintained and delivered to the Electrolyzer Cells 100. It should be appreciated that in other embodiments, the dissolution rate of converting zinc oxide to soluble zincate can be increased by adding heat to the hopper (306) or by circulating/stirring the aqueous electrolyte in the hopper cavity (308). Moreover, as discussed hereinabove, the electrical method 600 for minimizing or eliminating dendritic growth on the negative electrode 130 may be performed on the Electrolyzer Cell(s) 100 and includes applying a voltage (in the range of −1.5 V/cell−0 V/cell) across the positive terminal 128 and negative terminal 130 of the Electrolyzer Cell(s) 100 for a predetermined amount of time after a discharge or prior to a charge. It should be appreciated that the predetermined amount of time may be at least partially dependent on the size of the system and the number of Electrolyzer Cells 100 in the system. In one embodiment the voltage to be applied is −1 V/cell. It should be further appreciated that the electric current passing through one or more of the Electrolyzer Cell(s) 100 may be limited to prevent the current from exceeding a desired negative voltage per cell, such as −1 V/cell. One embodiment for accomplishing this may be to connect a diode in parallel to the positive terminal 128 and the negative terminal 130 of the one or more Electrolyzer Cell(s) 100.

In accordance with one embodiment, the Electrolyzer Cell(s) 100 as disclosed herein uses zincate as a reversible, electro-active material to controllably and spontaneously store and release energy. However, it is contemplated that in one or more other embodiments, other reversible, electro-active materials may be used as desired. Additionally, it should be appreciated that although the Electrolyzer Cells 100(s) is disclosed as having an electrolyte removal port 112 for removing electrolyte and dendritic material from the cell cavity 110 and an electrolyte replenishment port 132 for replenishing electrolyte into the cell cavity 110, it is contemplated that only one port may be included and may be used for both removing electrolyte and dendritic material from the cell cavity 110 and replenishing the cell cavity 110 with electrolyte.

It should be appreciated that in at least an embodiment, zincate is used as a reversible, electro-active material, wherein zincate is soluble in aqueous potassium or sodium hydroxide up to 6% by weight (when fully saturated), which corresponds to approximately 50 Amp hours (Ah)/liter of electrolyte. However, ‘super-saturated’ solutions having greater values are possible, wherein the higher capacity (i.e., super-saturation) may be achieved by replenishing depleted electrolyte (i.e., after a charge process where the zincate ion in solution is plated as zinc metal onto the negative electrodes during the charging process) with fully saturated electrolyte (such as may be supplied from an ‘electrolyte hopper’) and continuing the charging process. This process can be repeated several times. Then, after the subsequent discharge (i.e., zinc metal dissolves back to soluble zincate ion), the electrolyte will be ‘super-saturated.’ As such, the electrolyte can achieve approximately 3-5 times the capacity on the subsequent charge (without having to introduce additional electrolyte).

It should be further appreciated that charge is typically based on ‘capacity in’ (i.e., a charge current (Amps) for a set amount of time (hours) giving capacity (Ah).

Thus, a fully charged cell (i.e., when the electrolyte is depleted of zincate) is determined by voltage and ‘cell cutoff’ is defined as increase in voltage of greater than (>) 0.1 volts from a ‘baseline, steady-state’ voltage, wherein the ‘baseline, steady-state’ voltage is rate (Amps) dependent and also dependent on the electrode spacing, morphology and materials of the electrodes. In one embodiment, the Electrolyzer Cell(s) 100 uses copper foil and nickel foam as the material (i.e., copper foil—negative, nickel foam—positive,) and a spacing of ⅜ inch. In this embodiment, the ‘baseline’ voltage (i.e., when the zincate in electrolyte is not yet depleted) is 2.45 V (at a 250 mA/in² charge rate) and cell cutoff voltage is 2.6 V. At a slower charge rate (i.e., such as 125 mA/in²), the ‘baseline’ voltage may be 2.25 V and the charge cutoff is 2.4 V. It should be appreciated that the Electrolyzer Cell(s) 100 may be designed in many different variations and charge rates and voltages are dependent on the design of the Electrolyzer Cell(s) 100. As such, this invention contemplates other design characteristics (i.e., Materials, spacing, reversible, electro-active material) which fall within the scope of the invention, and which may depend upon the desired end purpose.

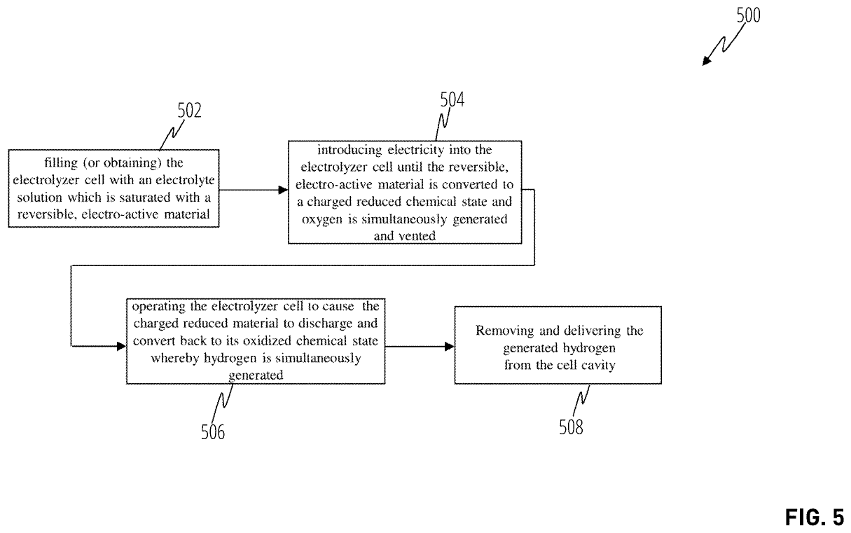

Referring to FIG. 5, a method 500 for implementing and maintaining the Electrolyzer Cell 100 is provided and includes filling (or obtaining) the Electrolyzer Cell 100 with an electrolyte solution which is saturated with Zincate, as show in operational block 502. The Electrolyzer Cell 100 is ‘charged’ by introducing electricity to the Electrolyzer Cell 100 via the positive terminal 129 and the negative terminal 130 until the reversible, electro-active material (i.e., Zincate) is fully charged, i.e., reduced (or as charged as desired), as shown in operational block 504. It should be appreciated that this ‘charging’ phase causes oxygen to be generated within the cell cavity 110. Accordingly, the oxygen that is generated during the ‘charging’ phase is removed from the cell cavity 110 out of the gas port 134. The Electrolyzer Cell 100 is then operated to cause the reversible, electro-active material to discharge, i.e., oxidized, as desired (i.e. such as during an on-peak electricity period) to generate spontaneous, on-demand hydrogen, as shown in operational block 506 and the generated hydrogen is then removed from the cell cavity 110 via the gas port 134, as shown in operational block 508. It should be appreciated that the generated hydrogen may be used as desired, such as delivered to a burner for heat, a turbine or engine for combined heat and power, fuel cell for power, and/or as a chemical feedstock, such as a reducing agent for clean steel production.

As discussed briefly hereinabove, the accumulation of precipitated zinc not only results in the loss of hydrogen capacity with time, but it also may lead to electrical shorts if the precipitated zinc bridges the positive and negative electrodes. Accordingly, it may be desirable to remove the precipitated zinc periodically. It should be appreciated that in one embodiment, the base cavity 122 may be “funnel-shaped” to receive and direct any precipitated zinc material (i.e., dendrites) to the electrolyte removal port 112 to aid in removal of precipitated zinc. It should be further appreciated that in another embodiment, the electrolyte removal port 112 and/or the electrolyte replenishment port 132 may be connected to a ‘maintenance system’ which may include a pump, a filter and an electrolyte hopper. This type of system may allow the Electrolyzer Cell 100 to be continuously (and/or periodically) maintained. For example, the pump may act to mechanically remove electrolyte containing precipitated zinc from the cell cavity 110 via the electrolyte removal port 112, feed the removed electrolyte through a filter to remove the precipitated zinc particles and deposit the filtered electrolyte into an electrolyte hopper where the filtered electrolyte may be used to replenish the electrolyte back into the cell cavity 110.

It should be appreciated that the electrolyte hopper may include dissolved zinc, such that when the filtered electrolyte is deposited into the electrolyte hopper, the electrolyte may be replenished with zinc to be fully saturated with soluble zincate. Accordingly, the electrolyte hopper may include an input port for fluid (such as water) and zinc oxide additions to allow the ‘maintenance system’ to maintain the electrolyte hopper with an electrolyte that is fully saturated with zincate (zinc oxide dissolves into soluble zincate in potassium or sodium hydroxide electrolyte). The “maintenance system” described above advantageously allows the Electrolyzer Cell 100 to maintain a stable amount a soluble zincate in the electrolyte and therefore a stable hydrogen delivery capacity with cycling.

It should be appreciated that the charging and discharging of the Electrolyzer Cell 100 is shown in the equations listed below. During the charging process, zincate is charged to zinc metal by applying a potential difference (i.e., voltage) greater than 1.6 V per cell across the positive and negative terminals. This may be accomplished via a power supply or any other power/voltage source suitable to the desired end purpose (i.e., solar cells, wind turbines, power grid, batteries, etc.). The zincate is converted to zinc on the negative electrode and oxygen is generated from hydroxyl ions (OH—) in an aqueous (water based) electrolyte on the positive electrode (See equations 1). During discharge, zine metal is discharged to zincate ion by connecting the positive and negative terminals to an electric load (i.e., such as a resistor, or any other type of electric load) that can provide a ‘discharge current.’ In one embodiment, the discharge voltage is less than (<) 0.4 V. Zinc is converted to zincate ion at the negative electrode and hydrogen is generated from water on the positive electrode (See equation 2). It should be appreciated that the Electrolyzer Cell 100 may not include a pump to remove either the hydrogen or oxygen, although one may be included if desired. These gases are less dense than the electrolyte and thus, move to the surface and outlet port via natural convection. Moreover, it should be appreciated that these gases are generated at a differential positive pressure above atmospheric pressure (i.e., the pressure of which can be controlled by a regulator at the ‘outlet gas port’ of a system) and therefore, these gases ‘flow’ to their desired destination (application) by being generated at a higher pressure than atmospheric pressure.

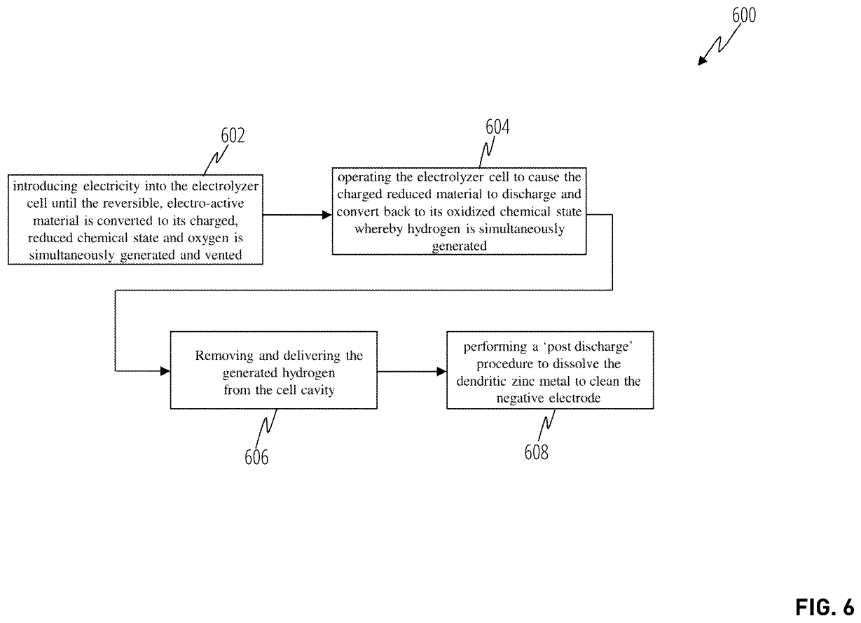

Referring to FIG. 6, a method 600 for reducing/preventing a dendritic zinc short circuit in the Electrolyzer Cell 100 is provided, in accordance with one embodiment of the invention. The method 600 includes charging the Electrolyzer Cell 100 by introducing electricity to the Electrolyzer Cell 100 via the positive terminal 129 and the negative terminal 130 until the reversible, electro-active material (i.e. Zincate) is fully charged, i.e., reduced, (or as charged as desired), as shown in operational block 602. It should be appreciated that this ‘charging’ phase causes oxygen to be generated within the cell cavity 110. Accordingly, the oxygen that is generated during the ‘charging’ phase is removed from the cell cavity 110 out of the gas port 134. The Electrolyzer Cell 100 is then operated to cause the reversible, electro-active material to discharge, i.e., oxidized, as desired (i.e. such as during an on-peak electricity period) to generate spontaneous, on-demand hydrogen, as shown in operational block 604 and the generated hydrogen is then removed from the cell cavity 110 via the gas port 134, as shown in operational block 606.

The method 600 further includes performing a ‘post discharge’ procedure, as shown in operational block 608, wherein the ‘post discharge’ procedure includes introducing a negative voltage across the positive terminal 129 and the negative terminal 130 (such as for example −1.5-0 volts/cell) for a predetermined period of time. This post discharge procedure enhances the dissolution of zinc metal to soluble zincate, thereby “cleaning” the first surface prior to the subsequent charge, which in turn significantly reduces or eliminates the development of dendritic electrical shorts. It should be appreciated that this post discharge procedure is beneficial because pockets of metallic zinc that did not fully discharge can remain on the first surface even after a discharge is terminated. These pockets of metallic zinc can act as surfaces for enhanced dendritic growth on the subsequent charge, which in turn, can lead to build-up of dendritic growth and thus, an electric short if the dendritic build-up bridges to the positive electrode. As described previously, an electric short results in “self-discharge” and hydrogen generation during a period it is unwanted. The “post discharge procedure” may be performed to advantageously remove any “undischarged” pockets of metallic zinc that may remain on the first surface.

It should be appreciated that when using zinc to generate hydrogen gas, the benefits of an alkaline electrolyte (potassium or sodium hydroxide) as compared to an acid electrolyte (such as, sulfuric or hydrochloric acid) are recognized. Zinc is unstable in an acid electrolyte, which is a drawback for energy storage applications. Thus, in an acid electrolyte, zinc formed during charge immediately starts “self-discharging” to ionic zinc and the simultaneous formation of hydrogen gas both during and on completion of the charge. As such, hydrogen gas is generated during a period it is unwanted, and thus is either lost completely or must be compressed and stored, which is costly. For example, one objective may be to charge a zinc system using intermittent renewable power sources, such as wind and/or solar, and then to “discharge” zinc to deliver hydrogen gas at a later time for heat and/or power. Due to the intermittent nature of solar and wind power, there will be periods when the zinc system is not charging, but the delivery of hydrogen gas is not yet desired. This may be true even if the source of the charge power is not wind or solar. Thus, in an acid electrolyte, zinc will immediately start “self-discharging” and prematurely releasing hydrogen gas. However, zinc is stable in a basic, alkaline electrolyte and there is no or minimal conversion of zinc-to-zinc ion and simultaneous hydrogen release during or following charge. Thus, there is no or minimal hydrogen capacity loss and in an alkaline electrolyte, charged zinc can be triggered electrically to generate hydrogen gas “on-demand” and when needed for delivery for heat, power, or as a chemical feedstock.

It should be appreciated that in many zinc-based energy storage devices, membranes or separators are used that are electrically insulating and ionically conductive, specifically for the hydroxyl ion. In zinc-based devices, examples of membrane material include cellulose, microporous polyethylene, microporous polypropylene, and other engineered plastics. The membrane or separator serves to electrically isolate the negative and positive electrodes from each other, while allowing for ionic conductivity. In addition to electrically separating the positive and negative electrodes, the separator also serves to physically block zinc dendrites, which grow during charge, from bridging the negative and positive electrodes, thus causing a short. Even in cells that incorporate membranes or separators, dendritic zinc bridges do occur with repeated cycling, due to the porous nature of these materials and the fact that the physical properties of these membranes degrade over time. Bridging can also result from overcharging. When a zinc dendritic bridge does occur, they are typically not reversible, i.e., the bridge penetrates the porous structure of the membrane/separator, becoming imbedded in the membrane. When this occurs, the result is significantly reduced performance or the end of life of the cell. The dendritic nature of zinc typically limits the cycle-life or calendar life of zinc based energy storage devices.

However, in at least one embodiment, a membrane or separator is not required. Rather, the positive and negative electrodes are spaced apart from each other, such that they do not touch, without a membrane or separator in-between. In one embodiment, the typical spacing between the positive and negative electrodes may be in the range of about 1/16 inches to about ½ inches. It should be appreciated that not including or requiring a membrane or separator has at least two benefits. First, it reduces the cost of the cell since membranes are expensive. Second, if and when a zinc dendritic bridge does occur, i.e., an internal electrical short develops, the absence of a membrane or separator allows for a full recovery from the short, thereby enabling a long cycle and calendar life device. This recovery does not occur on its own, but rather requires a discharge followed by the “post-discharge” procedure (described herein) and the appropriate amount of electrolyte (which may be defined by the spacing described above) between the electrodes and the appropriate amount of space below the electrodes, described hereafter. The “discharge/post-discharge” procedure causes the dendritic zinc bridge or zinc conglomerate to dissolve into the electrolyte, i.e., re-forming soluble zincate. Further, the reservoir of electrolyte within the cell must be sufficient to allow for the dendrite to dissolve when the discharge current is flowing. This is all controlled by the design of the cell.

It should be appreciated that in the presence of a membrane or separator, this “recovery procedure” would be hindered if not prevented since the dendrite would be imbedded in the porous structure of the membrane or separator which would inhibit the effect of the discharge/post-discharge procedure from dissolving the dendrite. As mentioned briefly above, the Electrolyzer Cell 100 may be designed with an adequate space below the electrodes, in one embodiment this may typically be about ½ inch to about 4 inches. This design advantageously enhances the full recovery from dendritic zinc bridges because it allows for a “drop zone” of the metallic zinc bridges or zinc conglomerates into the base of the cell that may contain a reservoir of electrolyte. The discharge/post-discharge procedure causes the zinc dendritic bridges and zinc conglomerates to detach from the electrode surfaces, fall into the electrolyte reservoir beneath the electrodes, and dissolve and/or be removed via the maintenance system as described herein. It should be further emphasized that if a membrane and separator are incorporated into cells by surrounding/enclosing the electrodes they inhibit this “drop zone” effect and thereby prevents achieving a long cycle-life and calendar life device. Accordingly, the combination of 1) the spacing between electrodes; 2) the size of the electrolyte reservoir beneath the electrodes; and 3) the lack of a membrane or separator, all contribute to having the desired effect of enabling a full recovery from zinc dendritic bridges and allowing for a long cycle and calendar life device.

Referring again to FIG. 1A, FIG. 1B and FIG. 1C, the Electrolyzer Cell 100 may include a plurality of positive electrodes 136 and negative electrodes 138, in accordance with one embodiment of the invention. The plurality of negative electrodes 138 may be constructed of metal, such as copper or copper foam, and the plurality of positive electrodes 136 may be constructed of a metal, such as nickel or nickel foam. The aqueous electrolyte is zincate ion fully or partially saturated in an alkaline electrolyte such as potassium or sodium hydroxide. It should be appreciated that, in one or more embodiments, multiple cells of the Electrolyzer Cell 100 of 1 may be constructed in series, parallel, or combinations thereof, to meet a desired input and output voltage during the charge and discharge procedures. Moreover, it should be appreciated that the electrolyte removal port 112 and/or electrolyte replenishment port 132 may serve for removal and replenishment of electrolyte such that the Electrolyzer Cell 100 may be able to cycle “indefinitely”.

In accordance with one embodiment of the invention, the process of spontaneous electrolysis may be expressed as follows:

### Charge Half-Cycle

When the charge half-cycle is initiated, the electrical energy required for electrolysis is stored in zincate. As the zincate in the electrolyte is reduced to Zn (converted to its high potential state) and oxygen is concurrently generated, the following is true:

Zn_{(aq)}²⁺+2e⁻→Zn₍ₛ₎(ΔU=+1.25 V)(1α, at negative)

2(OH)⁻→H₂O+½O₂+2e⁻(ΔU=+0.40 V)(1b, at positive)

Zn_{(aq)}²⁺+2(OH)⁻=Zn₍ₛ₎+H₂O+½O₂(ΔU=+1.65 V,+45 kWhₑ/8 kg O₂) (1)

### Discharge Half-Cycle

When the discharge half-cycle is initiated, Zn is oxidized back to zincate (converted to its low potential state), thereby delivering the electrical energy necessary to spontaneously electrolyze water to hydrogen gas (without any external energy input) and surplus electrical energy of 11 kWhₑ per kg H₂ is generated. This is shown below:

Zn₍ₛ₎→Zn_{(aq)}²⁺+2e⁻ΔU=−1.25 V)(2a, at negative)

2H₂O+2e⁻=2(OH)⁻+H₂(ΔU=+0.83 V)(2b, at positive)

Zn₍ₛ₎+2H₂O→Zn_{(aq)}^{2←}+2(OH)⁻H₂(ΔU=−0.42 V,−11 kWhₑ/kg H₂) (2)

It should be appreciated that the entire cycle (i.e., the charge half-cycle and the discharge half-cycle) is simply the electrolysis of water and is given by:

H₂O→H₂+½O₂(ΔU=+1.23 V,+34 kWhₑ/kg H₂) (3)

It should be appreciated that, in the above, a positive value is used to denote input electrical energy and a negative value is used to denote output (generated) electrical energy. Equation (1) is the charge half-cycle, requiring a theoretical electrical energy input of +45 kWhₑ/8 kg O₂. Equation (2) is the discharge half-cycle generating a theoretical electrical energy output of −11 kWh/kg H₂. Equation (3) is the full, round-trip cycle, which is simply the water electrolysis equation with a theoretical energy requirement of +34 kWhₑ/kg H₂.

Thus, equation (1) is the “energy storage” step, where electrical energy is electrochemically stored by converting zincate to zinc, wherein O₂ gas is concurrently generated. As shown by equation (2), the stored energy is released when the discharge step is initiated and water is spontaneously electrolyzed to generate hydrogen gas (i.e., no input energy required). It should be further noted that the rate of spontaneous H₂ generation can be precisely controlled by adjusting the load (i.e., discharge current). It should be appreciated that another means of spontaneously generating the hydrogen gas is connecting the positive and negative terminals of the cell with an electrical conductor such as copper or any metal that conducts electric current. It should be further appreciated that, in one embodiment of the invention, the hydrogen gas generated spontaneously during the discharge half-cycle passes out the gas port 134 and can be passed to its intended application, such as heat, power, or as a chemical feedstock (reduction of iron ore for clean steel manufacturing). One advantage of at least an embodiment, compared to conventional electrolyzers, is that hydrogen can be burned/oxidized in a furnace or engine or converted to electricity in a fuel cell at “time-of-generation” since the hydrogen is “spontaneously generated,” (i.e., no input energy is required during the generation phase) thereby bypassing the “compression and storage” step, which is required of conventional, state-of-the-art electrolyzers.

It should be appreciated that although at least an embodiment put some emphasis on eliminating hydrogen compression and storage costs via the unique and novel features and methods for particular energy storage applications, there exists many other applications, such as seasonal or long-duration energy storage, where compression and storage of hydrogen is or may be required. Long-duration or seasonal energy storage is where, for instance, surplus renewable energy, in the spring or fall months, is typically harvested for use in winter, when heat demand is high. Moreover, a compressor can be any type of device that increases hydrogen from a low pressure to a higher pressure. Types of compressors may include electrochemical compressors and/or mechanical compressors and Hydrogen storage devices/facilities can include tanks and/or naturally occurring reservoirs, such as salt caverns.

As was discussed previously hereinabove, gas compression is costly, mainly due to the Capital Expense (i.e., CapEx) of compression, wherein the CapEx of compression is proportional to the power (KW) required to compress the Hydrogen. Typically, the CapEx of compression ranges between $1,000/kW-$4,000/kW of compression power, with the range depending on the compressor type and scale. The required power typically depends on the flow rate, input and output pressure, and the physical properties of the gas being compression. One expression that shows the relationship between these variables can be inferred from the Nernst equation of compression which is given as:

Required Power of Compression (kW)=aV ln(P2/P1),
where P1 and P2 are the input and output pressure of the gas delivered to the compressor, V is the gas flow rate, and a is the proportionality constant which accounts for the physical properties of the gas and the efficiency. As shown by the Nernst equation, the power of compression, and therefore the CapEx of compression, is directly proportional to the flow rate of the gas. Thus, it stands to reason that any method that enables a user to decrease the flow rate of a gas required to store a given amount of electrical energy (such as Hydrogen gas) also reduces the CapEx of the gas compression.

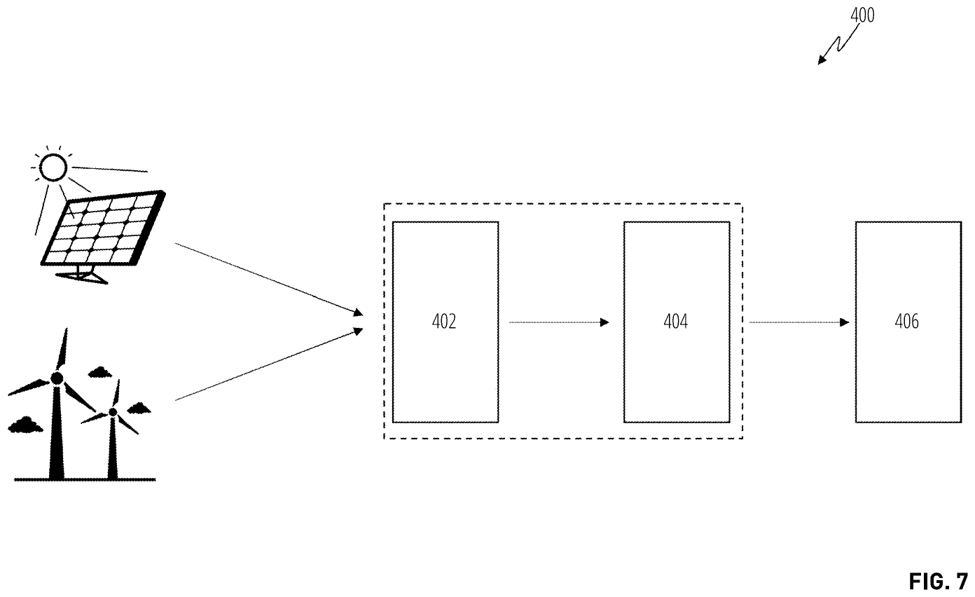

Referring to FIG. 7, a Spontaneous Electrolyzer System (SES) 400 having an Electrolyzer Cell (or SECS) 402 integrated with a Compressor 404 is provided, in accordance with one embodiment of the invention, wherein the SES 400 is configured for long-duration energy storage applications. As discussed previously and referring to the Nernst equation, the output hydrogen generation flow rate from an electrolyzer equals the input flow rate fed to the compressor (i.e., V in the Nernst equation). Using a conventional electrolyzer, water is electrolyzed (i.e., split) in a single step, therefore the rate of input electrical energy and the hydrogen generation rate is “coupled”. However, using the Electrolyzer Cell (or SECS) 402, water is electrolyzed (i.e., split) in two steps, therefore the rate of input electrical energy and the rate of hydrogen generation is advantageously “de-coupled”. It should be appreciated that this “de-coupling” is explicit in the charge and discharge reactions of equations (1) and (2) hereinabove. Thus, the Electrolyzer Cell (or SECS) 402 can charge at one rate (i.e., oxygen flow rate) and can discharge at another rate (i.e., hydrogen flow rate), such as a lower rate. Therefore, the compression power required to compress an amount of hydrogen gas to an output pressure can be smaller than with a conventional electrolyzer. This feature is highly favorable for renewable energy storage applications, which may be intermittent. It should be appreciated that once the generated hydrogen gas is generated and compressed, the hydrogen gas may then be stored within a storage device/facility 406 for later use.

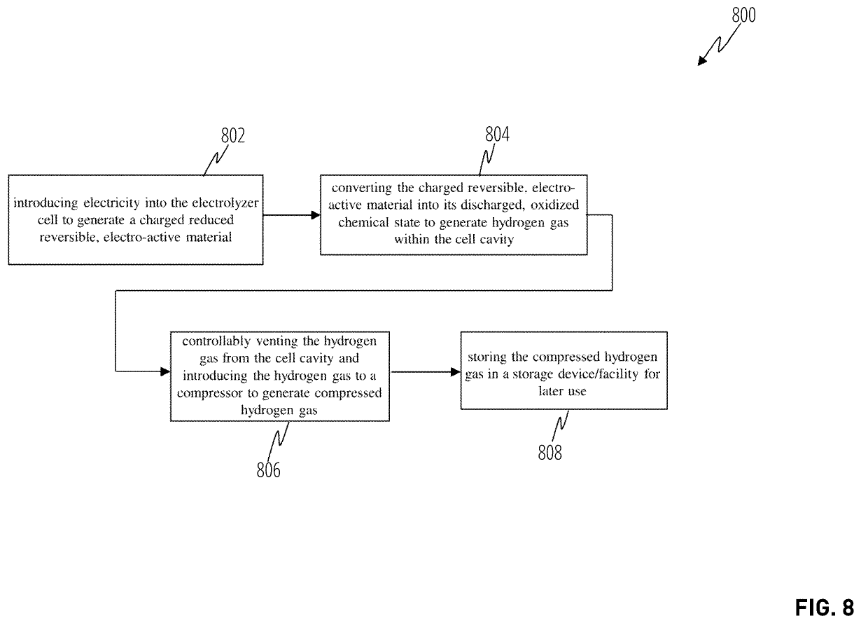

Referring again to FIG. 8, a method 800 for generating, compressing and storing hydrogen gas using the Spontaneous Electrolyzer System (SES) 400 having an Electrolyzer Cell (or SECS) 100, 402 integrated (and/or in flow communication) with a Compressor 404 is provided, in accordance with one embodiment of the invention. The method 800 includes introducing electricity into the Electrolyzer Cell 100, 402 to cause the reversible, electro-active material contained within the Electrolyzer Cell 100, 402 to be converted into a charged, reduced chemical state, as shown in operational block 802. It should be appreciated that the introduction of electricity into the Electrolyzer Cell 100, 402 may be performed during specific and limited times depending upon the source of the electricity. For example, if the source of the electricity are solar cells, then the introduction of electricity into the Electrolyzer Cell 100, 402 may occur only during daylight hours.

The method 800 further includes converting the charged, reduced reversible, electro-active material into its discharged, oxidized chemical state by applying an electrical load (and/or an electrical short, as desired) across at least one positive electrical terminal and at least one negative electrical terminal to cause an electrical current to flow through the electrical load, as shown in operational block 804. This causes the Electrolyzer Cell (or SECS) 100, 402 to generate hydrogen gas within the cell cavity (or cell cavities) 110. It should be appreciated that the rate that the hydrogen gas is generated by the Electrolyzer Cell (or SECS) 100, 402 may be controlled by controlling the electrical current flowing through the electrical load. The generated hydrogen gas may be controllably vented from the Electrolyzer Cell (or SECS) 100, 402 and controllably introduced into the Compressor 404 to be compressed thereby generating compressed hydrogen gas, as shown in operational block 806. The compressed hydrogen gas may then be stored within a storage device/facility 406 (for example, a salt cavern which may be 100-200 bar) for later use, as shown in operational block 808. Then, when surplus renewable energy (i.e., electricity) is no longer available, the Spontaneous Electrolyzer System (SES) 400 is no longer operating and is “off/idle” until the subsequent surplus renewable energy period, i.e., the next day between 10 am-2 pm. However, the compressed hydrogen gas that was stored within the storage device/facility 406 may be directed/delivered to devices that use hydrogen as fuel for generating heat or power.

Referring again to FIG. 7, one example showing the SES 400 being implemented using the method is described immediately hereinafter. It should be appreciated that this example is intended to demonstrate some of the advantages of SES 400 compared to a conventional electrolyzer/compressor system. It is contemplated that this method of operation can be applied to many different types of embodiments and similar types of examples and applications.

It should be appreciated that when surplus renewable energy is available, it is typically available for only a short time. For example, surplus solar energy may only be available for harnessing during the daytime, say for four (4) hours (such as for example, between 10 am-2 pm). In current systems, modes of operation for long-duration hydrogen storage may use existing electrolyzers, such as, for example, a Polymer Electrolyte Membrane (PEM) electrolyzer coupled with a compressor. The PEM electrolyzer may be operated for the four (4) available hours daily when the surplus renewable energy is available. The generated hydrogen from the PEM electrolyzer is passed to a compressor, which in turn, increases the pressure of the hydrogen gas to the required pressure of the storage device/facility 406 (for example, a salt cavern which may be 100-200 bar). Then, when surplus renewable energy (i.e., electricity) is no longer available, the system is no longer operating and is “off/idle” until the subsequent surplus renewable energy period, i.e., the next day between 10 am-2 pm.

In this example, the PEM electrolyzer/compressor combination is typically “sized” to store a given amount of surplus solar electricity that is generated during this 4 hour duration period, and the average hydrogen flow rate passed to the storage facility during this 4 hour period is defined as V₁. As an example, a PEM electrolyzer sized for a delivery of 1 kg H₂/h may require an electrical input of approximately 50 kWh/kg H₂, and therefore, if PEM electrolyzer was operated for 4 hours a total of 200 kWh of surplus solar electrical energy may be harvested by passing a total of 4 kg H₂ to the compressor during that 4 hour period. This equates to an average flow rate of V₁=4 kg H₂/4 h=1 kg H₂/h. Therefore, according to the Nernst equation above, the required compression power to store 4 kg H₂ using a PEM electrolyzer is given as kW₁=a V₁ ln(P2/P1). It should be noted that, in this example, the PEM electrolyzer is idle the remaining twenty (20) hours of the day (since there is no surplus solar energy available to store), and therefore, the total amount of hydrogen stored is only 4 kg H₂ per day.

However, in accordance with at least an embodiment, the SES 400 may include an Electrolyzer Cell (or SECS) 402 that is ‘sized’ and configured to perform the same task as the PEM electrolyzer, i.e., store 200 kWh of surplus solar electricity during an available four (4) hour window to allow a total of 4 kg H₂ to be passed to a storage device/facility 406 per day. In this embodiment, the electrical energy is generated and stored according to a chemical reaction given by equation (1) hereinabove, when the zincate within the Electrolyzer Cell (or SECS) 402 is converted to zinc and the oxygen gas is vented to the atmosphere. It should be appreciated that in order to generate an equivalent of 4 kg H₂ (i.e., 2,000 moles H₂) during the discharge period, the Electrolyzer Cell 402 is sized to convert 2,000 moles of zinc-ion to zinc metal and simultaneously generate and vent 1,000 moles of O₂ during the charge period. These reactions are described in the stoichiometry of equations (1) and (2) hereinabove. It should be further appreciated that the charge is performed during the four (4) hour charge window period when the surplus solar electricity is available and when the surplus solar electricity is no longer available, the Electrolyzer Cell (or SECS) 402 may be turned off, i.e., idle.

At the end of the four (4) hour charge period window (i.e., 2 pm), the Electrolyzer Cell (or SECS) 402 may then be discharged at a rate that will allow the Electrolyzer Cell (or SECS) 402 to be fully discharged in time to be ready for re-charging at the beginning of the next four (4) hour surplus solar charge period window, i.e., 10 am the next day. The discharge current may be controlled such that the 2,000 moles of zinc metal that was formed during the four (4) hour surplus solar charge period window is converted back to zinc-ion during the period where the surplus solar electricity is not available (i.e., 2 pm on day 1 to 10 am on the day 2). It should be appreciated that during this conversion period, 2,000 moles (i.e., 4 kg H₂) of hydrogen are simultaneously and spontaneously generated via the conversion process, wherein the rate of this generated hydrogen sourced from the Electrolyzer Cell (or SECS) 402 is V₂=4 kg H₂/20 h=0.2 kg H₂/h. During this 20-hour discharge period, the hydrogen that is generated by the Electrolyzer Cell 402 is passed to the Compressor 404 and compressed by the Compressor 404 which is configured to compress the generated hydrogen to the pressure value (P2) of the storage device/facility 406, wherein the required compression power necessary to store 4 kg H₂, according to the equations hereinabove, is kW₂=a V₂ ln(P2/P1).

It should be appreciated that, as shown in the above example, the SES 400 advantageously requires only 20% of the power required compared to current systems. Accordingly, the SES 400 reduces the CapEx by 80% while accomplishing the desired objective. One reason for this is that at least an embodiment of the disclosure advantageously has a hydrogen flow rate, V₂, that is one-fifth of the flow rate of V₁. This advantage is a direct result of the unique features of the SES 400 that allows for “de-coupling” the rate of input electrical energy and the hydrogen generation rate, as described hereinabove. This feature advantageously inherently lowers the levelized cost of hydrogen energy storage, which is directly related to the CapEx of the equipment when surplus electricity is available. It should be appreciated that although the above example is given with regards to surplus solar electricity, any type of energy source may be used to introduce electricity into the Electrolyzer Cell 100, 402 . . . such as wind power or off-peak nuclear power.

It should be appreciated that, in accordance with one or more embodiments of the invention, the Electrolyzer Cell 100, 402 and/or the method(s) of the invention as disclosed herein may be implemented as desired via any devices suitable to the desired end purpose, such as a processor, digital devices, analog devices and/or a combination of digital and analog devices. Thus, it is contemplated that, in accordance with one or more embodiments of the invention, the processing of the invention may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

Moreover, at least an embodiment of the method may be embodied in the form of a computer or controller implemented processes. The method of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the systems and methods describe above address some of the zinc-related challenges through post-discharge procedures and system design considerations, significant opportunities remain for further optimization of ZHB performance. The formation of dendritic versus dense zinc morphology during charging is influenced by multiple factors including electrode geometry, current density distribution, and electrolyte composition and concentration.

Electrode edge effects represent a particularly challenging aspect of dendritic formation. On planar conductive electrodes, current density is inherently non-uniform near electrode edges, with the magnitude of these edge effects strongly influenced by the geometry of adjacent insulator(s). When the insulators form angles greater than 90° relative to the electrode plane, current density at electrode edges can approach infinite values, creating conditions that strongly favor dendritic zinc growth. Dendrites formed at electrode edges are particularly problematic as they tend to be non-reversible and cannot be effectively addressed through the post-discharge procedures described above.

The morphology of zinc deposition during charging can be categorized into two distinct types: dense morphology, which is operationally advantageous, and porous/dendritic morphology, which is detrimental to system performance. Dense zinc morphology allows for greater active material deposition before physical contact between electrodes, thereby increasing cell capacity and hydrogen delivery per cycle while minimizing self-discharge. Conversely, dendritic morphology leads to premature electrode bridging, reduced capacity, high self-discharge rates, and poor round-trip efficiency.

The type of zinc morphology that forms during charging may be primarily determined by the surface concentration of zincate at the electrode-electrolyte interface. This surface concentration differs from the bulk electrolyte concentration and is influenced by both the bulk zincate concentration and the applied current density during charging. While bulk zincate concentration is measurable, surface concentration is at a microscopic scale and can only be estimated indirectly through spectroscopic or computational methods. Current densities create ionic concentration gradients in the local surface region that can promote either dense or dendritic growth depending on the specific operating conditions. Further, the bulk concentration influences the surface concentration, which can promote either dense or dendritic growth depending on the specific operating conditions. A lower bulk concentration results in a lower surface concentration, and vice versa. A higher current density results in a lower surface concentration, and vice versa.

An operational threshold exists where surface zincate concentration determines whether dense or dendritic morphology predominates. When surface concentration exceeds this threshold, detrimental dendritic zinc grows, while surface concentrations below the threshold promote preferable dense zinc formation. This threshold can be controlled operationally via controlling either or both of the bulk concentration and the applied current density. This relationship can be expressed empirically as:

i>0.042c+0.068 (4)

where i is the applied current density (Amps/in²) and c is the bulk zincate concentration in the electrolyte (weight percent). This empirical equation defines the minimum applied current density at a given bulk zincate concentration that is required to promote the preferable dense zinc morphology during charge.

While this relationship provides guidance for operating conditions that promote dense zinc growth, practical implementation faces several challenges. At higher zincate concentrations, the minimum current required to maintain dense growth may result in unacceptably high overvoltages and poor round-trip efficiency. Additionally, variable renewable energy sources can create wide current ranges during charging, making it difficult to maintain optimal conditions throughout the charge cycle. Operating at lower zincate concentrations can address these issues but reduces the theoretical capacity available within a given electrolyte volume. Furthermore, even under optimal conditions that promote dense zinc growth, eventual bridging between electrodes may be inevitable as the charging process continues.

In an exemplary embodiment described in further detail below, a low zincate bulk concentration was used to achieve the desired dense zinc morphology at a lower applied current density. As described above, the lower zincate bulk density may result in an overall lower total capacity of the system for a given volume of zincate. Accordingly, in at least an exemplary embodiment described below, a reservoir of electrolyte solution is provided with a volume larger than that of the sum of the total volume of the cells in the battery system, and a pump system may be provided to circulate the electrolyte solution through the battery system. Thus, the overall capacity of the battery system can still be maintained at the desired level despite the bulk concentration of the zincate in the solution being at a reduced level by virtue of the increased total volume of the electrolyte solution.

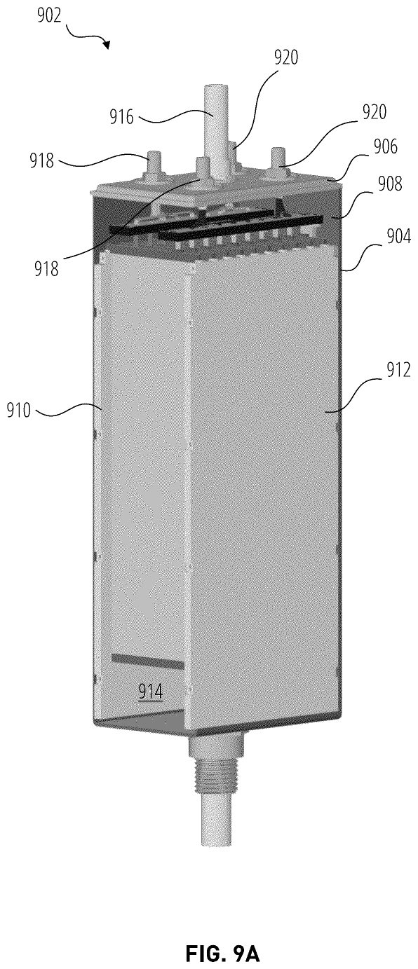

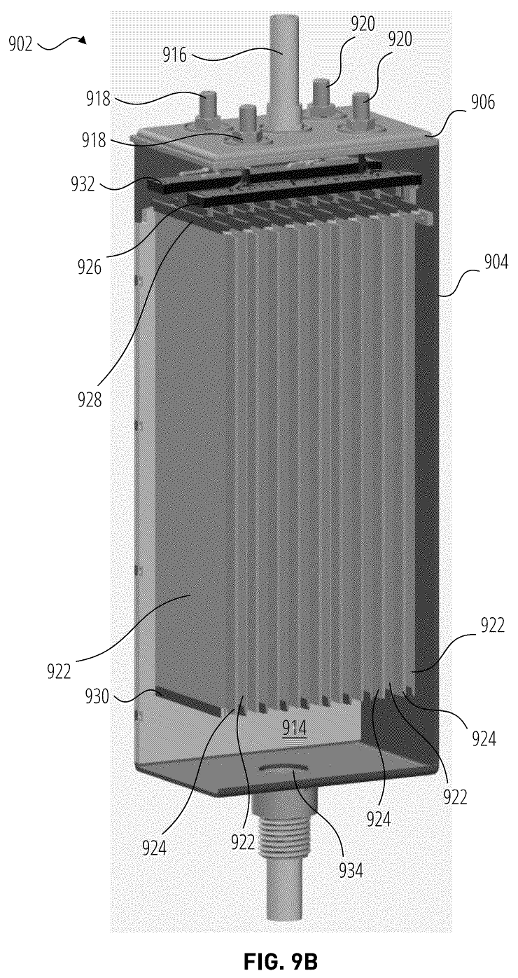

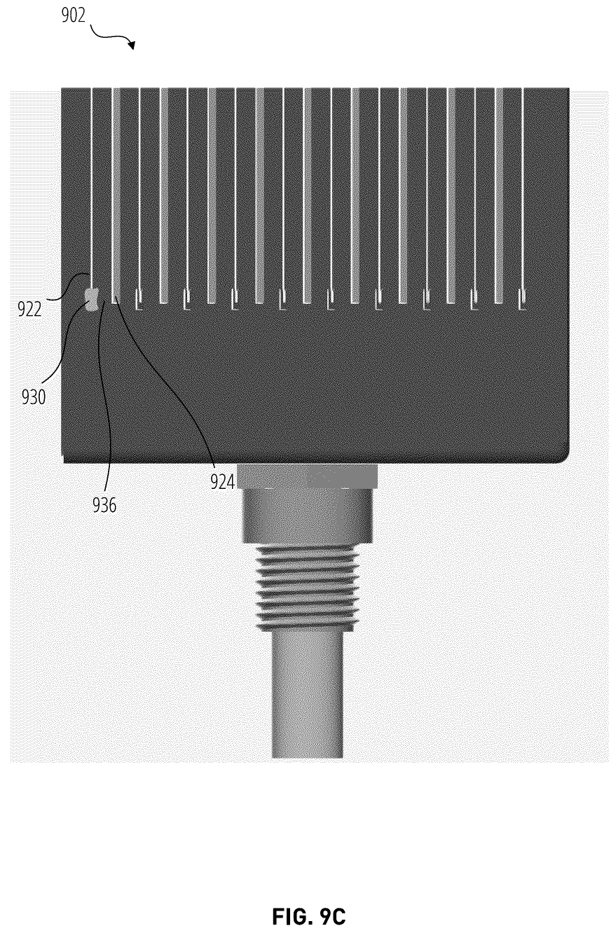

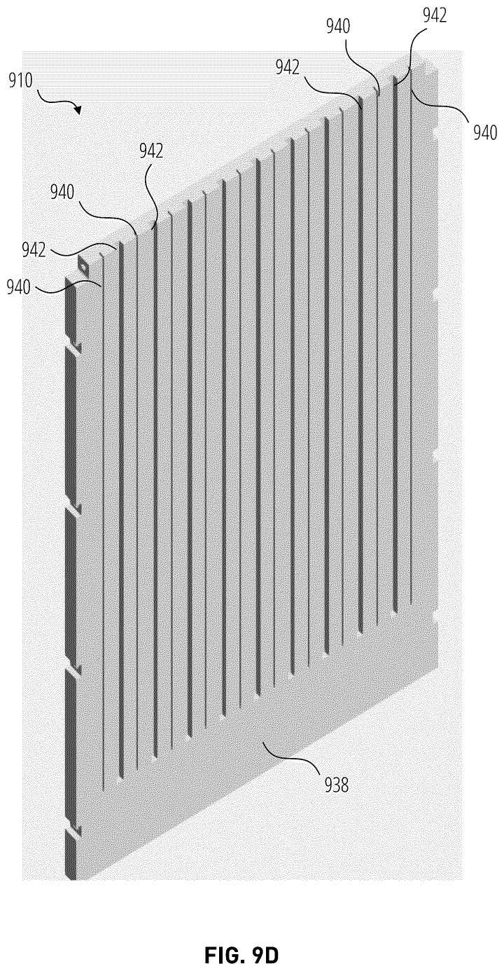

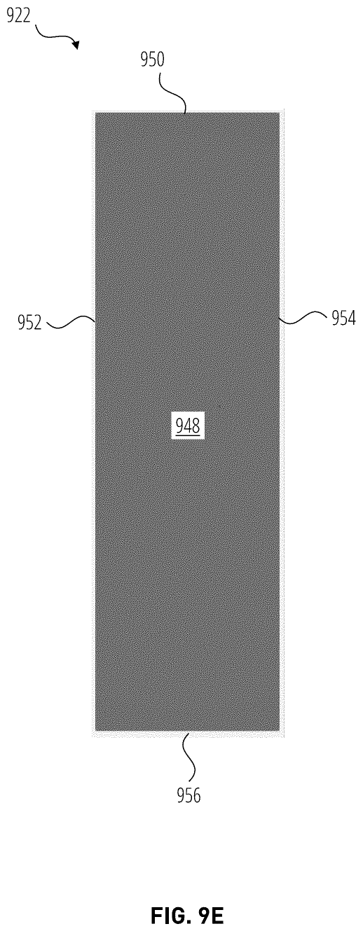

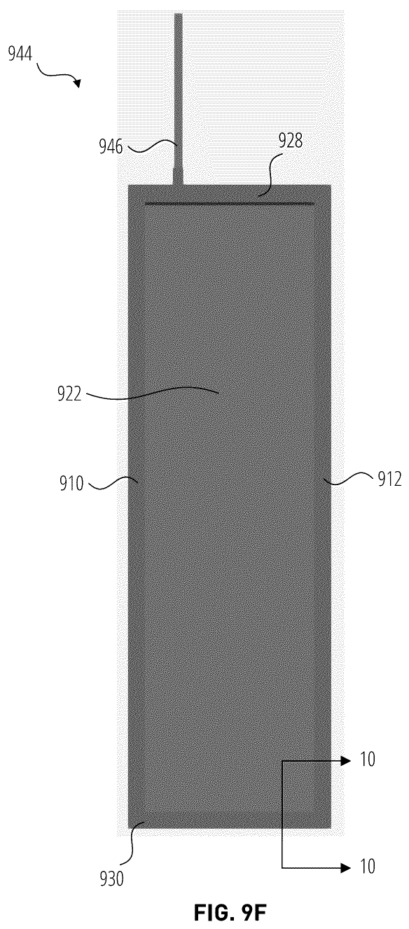

At least an exemplary embodiments will be described herein that may help to minimize or eliminate dendritic growth during the charge of a zinc hydrogen cell that may be used to spontaneously generate hydrogen gas during discharge. FIG. 9A shows a perspective view of a zinc hydrogen cell 902 according to an exemplary embodiment. The zinc hydrogen cell 902 may include a cell case 904 and a cell cover 906 defining a cell interior 908. A first electrode frame 910 and a second electrode frame 912 may be provided within the cell interior 908. In an exemplary embodiment, the cell interior 908 may be filled with an aqueous electrolyte such, but not limited to, a zincate ion saturated in an alkaline electrolyte such as potassium hydroxide or sodium hydroxide. In an exemplary embodiment, the zincate may have a concentration in a range of 0.1%-3% by weight. The potassium hydroxide or sodium hydroxide may have a concentration in a range of 5%-45% by weight in water. This concentration of zincate may help to promote the conditions for dense zinc morphology during charge of the zinc hydrogen cell 902. A base cavity 914 may be provided within the cell case 904 between the first electrode frame 910 and the second electrode frame 912 and below negative electrodes 922 and positive electrodes 924 (see also FIG. 9B).

FIG. 9B shows the zinc hydrogen cell 902 with the second electrode frame 912 removed for visibility of additional structure. Within the first electrode frame 910, a plurality of negative electrodes 922 and a plurality of positive electrodes 924 may be arranged in an alternating pattern. It will be understood that, for clarity of the drawings, each individual negative electrode and each individual positive electrode are not separately labelled. The negative electrodes 922 and the positive electrodes 924 may be arranged as substantially parallel flat plate-shaped structures extending from a top of the cell case 904 to a bottom of the cell case 904. The negative electrodes 922 may comprise a material configured to reduce zincate to zinc metal and oxidize zinc metal to zincate reversibly. For example, the negative electrodes 922 may comprise a metal such as copper or copper foam, but it will be understood that the disclosure is not limited to these metals. Each negative electrode 922 may be in electrical communication with the negative terminals 920, for example via a negative bus 926. The negative bus 926 may be either conductive or insulating. For example, in an exemplary embodiment, the negative bus 926 may be a conductive piece of metal that is in electrical communication with each negative electrode 922. In an alternative exemplary embodiment, the negative bus 926 may be formed of an insulating material such as plastic, and conductive leads may extend through the plastic. Forming the negative bus 926 from an insulating material may help to prevent formation of zinc dendrites on the conductive portions (such as the leads within the plastic) during charging. In an exemplary embodiment, the conductive leads within the plastic of the negative bus 926 may further include flexible sleeve insulators provided on the conductive leads.

Additionally, a top insulator sleeve 928 may be provided at a top edge of each negative electrode 922, and a bottom insulator sleeve 930 may be provided at a bottom edge of each negative electrode 922. The top insulator sleeve 928 and the bottom insulator sleeve 930 may be formed of an electrically insulating material such as, but not limited to, plastic. Additionally, the material of the top insulator sleeve 928 and the bottom insulator sleeve 930 may be chemically resistant to the electrolyte used in the zinc hydrogen cell 902. For example, the top insulator sleeve 928 and the bottom insulator sleeve 930 may be formed of polypropylene, polyethylene, polyvinylchloride, or acrylonitrile butadiene styrene, but it will be understood that the disclosure is not limited to these materials.

The positive electrodes 924 may be comprise a material configured to catalyze electrochemical formation of at least one of hydrogen gas and oxygen gas from an electrolyte. For example, the positive electrodes 924 may comprise a metal such as nickel or nickel foam, but it will be understood that the disclosure is not limited to these materials. Each positive electrode 924 may be in electrical communication with the positive terminals 918, for example via a positive bus 932.

FIG. 9C shows a side view of the zinc hydrogen cell 902 with the second electrode frame 912 removed for visibility of additional structure. FIG. 9C further illustrates the mutually parallel configuration of the negative electrodes 922 and the positive electrodes 924. FIG. 9C further shows a gap 936 provided between each adjacent pair of a negative electrode 922 and a positive electrode 924. The gap 936 allows for fluid communication and flow for the entirety of space between each adjacent pair of a negative electrode 922 and a positive electrode 924.

FIG. 9D shows a perspective view of the first electrode frame 910 according to an exemplary embodiment. The first electrode frame 910 may comprise an electrically insulating material, such as, but not limited to, plastic, and may be formed in a substantially plate-shaped structure. Additionally, the first electrode frame 910 may be formed of a material that is chemically resistant to the electrolyte used in the zinc hydrogen cell 902. For example, first electrode frame 910 may be formed of polypropylene, polyethylene, polyvinylchloride, or acrylonitrile butadiene styrene, but it will be understood that the disclosure is not limited to these materials. The first electrode frame 910 may include an interior surface 938 that faces the negative electrodes 922 and the positive electrodes 924. A plurality of negative electrode slots 940 and a plurality of positive negative electrode slots 942 may be formed in the interior surface 938 of the first electrode frame 910. The negative electrode slots 940 and the positive negative electrode slots 942 may be arranged in an alternating pattern matching the arrangement of the negative electrodes 922 and the positive electrodes 924. Each negative electrode slot 940 may be dimensioned to receive a lateral edge of a negative electrode 922 therein, and each positive negative electrode slot 942 may be dimensioned to receive a lateral edge of a positive electrode 924 therein. While a separate view of the second electrode frame 912 is not shown, it may be understood that the second electrode frame 912 may be a substantially mirror image copy of the first electrode frame 910, with corresponding negative electrode slots 940 and positive negative electrode slots 942 for receiving opposite lateral edges of the negative electrodes 922 and the positive electrodes 924. Additionally, the second electrode frame 912 may be formed of a material similar to that of the first electrode frame 910.

FIG. 9E shows a view of a negative electrode 922 according to an exemplary embodiment. As noted above, the negative electrode 922 may be formed in a substantially plate-shaped form. The negative electrode 922 may include a first surface 948, a top edge 950, a first lateral edge 952 adjacent to the top edge 950, a second lateral edge 954 adjacent to the top edge 950 and opposite the first lateral edge 952, and a bottom edge 956 opposite the 950 and adjacent to the first lateral edge 952 and the second lateral edge 954. While FIG. 9E depicts the negative electrode 922 as a four-sided plate, it will be understood that the disclosure is not limited to this embodiment and that other shapes of electrodes are possible. For example, an alternative embodiment may use ring-shaped electrodes.

FIG. 9F shows a view of negative electrode assembly 944 according to an exemplary embodiment. The top edge 950 (not shown in FIG. 9F, see FIG. 9E) may be inserted into the top insulator sleeve 928. A connector 946 may extend through the top insulator sleeve 928 to provide electrical communication between the negative electrode 922 and the negative bus 926 (see FIG. 9B). The first lateral edge 952 and the second lateral edge 954 (not shown in FIG. 9F, see FIG. 9E) may be inserted into corresponding negative electrode slots 940 (see FIG. 9D) of the first electrode frame 910 and the second electrode frame 912. The bottom edge 956 (not shown in FIG. 9F, see FIG. 9E) of the negative electrode 922 may be inserted to the bottom insulator sleeve 930. In this way, each negative electrode 922 may be configured such that each edge on all sides is enclosed by an electrically insulating material. In other words, the top edge 950 of each negative electrode 922 may be fully inserted into the top insulator sleeve 928, the first lateral edge 952 of each negative electrode 922 may be fully inserted into the first electrode frame 910, the second lateral edge 954 of each negative electrode 922 may be fully inserted into the second electrode frame 912, and the bottom edge 956 of the negative electrode 922 may be fully inserted into the bottom insulator sleeve 930.

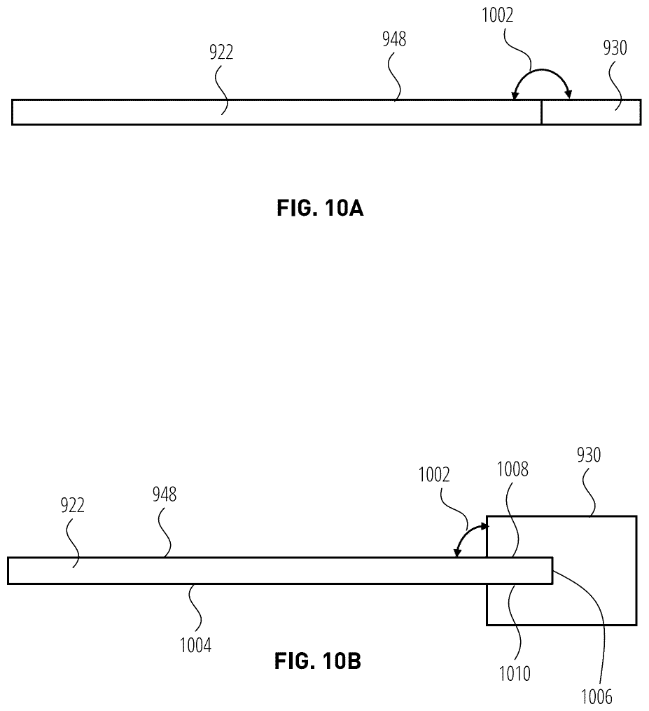

FIG. 10A and FIG. 10B illustrate cross sections of exemplary embodiments of a negative electrode 922 and a bottom insulator sleeve 930 taken along line 10-10 in FIG. 9F. It will be understood that the embodiments shown in FIG. 10A and FIG. 10B are not drawn to scale and that dimensions may be exaggerated in order to better illustrate certain concepts. As seen in FIG. 10A and FIG. 10B, there may be an angle 1002 between the first surface 948 and the bottom insulator sleeve 930. In FIG. 10A, the angle 1002 is approximately 180 degrees. In FIG. 10B, the angle 1002 is approximately 90 degrees. In an exemplary embodiment of the zinc hydrogen cell 902, the angle 1002 will be less than or equal to 90 degrees. When the angle 1002 is less than or equal to 90 degrees, current density near an edge of the negative electrode 922 may be minimized, which in turn minimizes dendritic zinc growth on the edges of the negative electrode 922 during a charge procedure. While FIG. 10A and FIG. 10B show the angular relationship between the negative electrode 922 and the bottom insulator sleeve 930, it will be understood that this angular relationship can be equally applied between the negative electrode 922 and the top insulator sleeve 928, the first electrode frame 910, and the second electrode frame 912 as well, and that setting the angle between the first surface and the top insulator sleeve 928, the first electrode frame 910, and second electrode frame 912 will similarly minimize current density and dendritic zinc growth along those edges as well. It will be understood that the structure of the zinc hydrogen cell 902 is not limited to the specific embodiments shown in FIG. 10A and FIG. 10B. For example, in an exemplary embodiment, the top insulator sleeve 928 and the bottom insulator sleeve 930 may have cross sections that are not rectilinear in shape; for example, cross sections of the top insulator sleeve 928 and the bottom insulator sleeve 930 may be circular or elliptical in shape.

In an exemplary embodiment as shown in FIG. 10B, the negative electrode 922 may have the first surface 948, a second surface 1004, and an edge surface 1006 extending between the first surface 948 and the second surface 1004. The first surface 948 may include a first surface periphery 1008 extending from a boundary with the edge surface 1006, and the second surface 1004 may include a second surface periphery 1010 extending from a boundary with the edge surface 1006. As seen in FIG. 10B, the bottom insulator sleeve 930 may cover or enclose the edge surface 1006, the first surface periphery 1008, and the second surface periphery 1010. In an exemplary embodiment, the first surface periphery 1008 and the second surface periphery 1010 may extend 0.125 inches to 0.5 inches away from the edge. In other words, the bottom insulator sleeve 930 may cover 0.125 inches to 0.5 inches of the surface from the edge of the negative electrode 922. For example, a depth of the channels in the bottom insulator sleeve may be 0.125 inches to 0.5 inches. It will be understood that the disclosure is not limited to this range of dimensions. In an exemplary embodiment, the bottom insulator sleeve 930 may contact the edge surface 1006, the first surface periphery 1008, and the second surface periphery 1010. While FIG. 10B illustrates the relationship between the negative electrode 922 and an insulator at one edge of the negative electrode 922, it will be understood that this relationship may also apply equally to any other edges of the negative electrode 922 such that edge current density may be minimized around an entire periphery of the negative electrode 922.

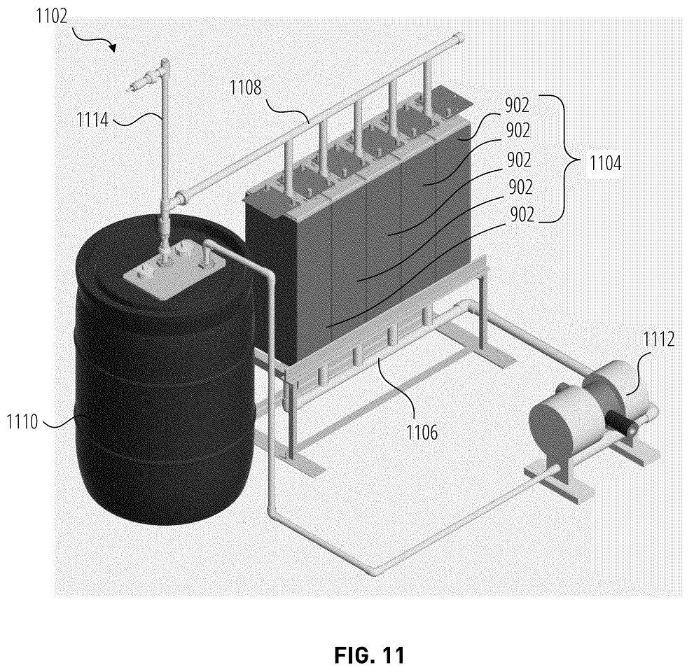

FIG. 11 shows an exemplary embodiment of a zinc hydrogen battery system 1102. The zinc hydrogen battery system 1102 may include a zinc hydrogen battery 1104 comprising a plurality of zinc hydrogen cells 902 connected in series. While FIG. 11 shows five zinc hydrogen cells 902 connected in series, it will be understood that the disclosure is not limited to this and that more or less zinc hydrogen cells 902 may be used. Further, it will be understood that the zinc hydrogen cells 902 may be connected in series, in parallel, or in a combination of series in parallel in order to meet the desired input and output voltage during charge and discharge.

The description below will be made with additional reference to FIG. 9A through FIG. 9E for purposes of any reference numerals that are not expressly shown in FIG. 11. In an exemplary embodiment, each individual zinc hydrogen cell 902 may define a volume of approximately 5 gallons (or approximately 20 liters). The negative electrodes 922 of each zinc hydrogen cell 902 may be formed of copper foil. The positive electrodes 924 of each zinc hydrogen cell 902 may be formed of nickel foam. Each zinc hydrogen cell 902 of the zinc hydrogen battery 1104 may include 10 negative electrodes 922 and 9 positive electrodes 924 arranged in an alternating configuration. Each zinc hydrogen cell 902 may include a first electrode frame 910 and a second electrode frame 912 configured such that there is spacing of 0.375 inches between each adjacent electrode. In an exemplary embodiment, each electrode may be approximately 17.6 inches long and approximately 5 inches wide. In an exemplary embodiment, the negative electrode 922 may be approximately 0.015 inches thick, and the positive electrode 924 may be approximately 0.120 inches thick. In other words, the total active electrode area for each zinc hydrogen cell 902 may be approximately 1584 square inches (considering both sides of each positive electrode 924). All edges of the negative electrodes 922 may be enclosed by insulating material such as described above with reference to FIG. 9F and FIG. 10B. In an exemplary embodiment, a minimum current per zinc hydrogen cell 902 may be in a range of 150-250 amps.

The zinc hydrogen battery system 1102 may further include a first manifold 1106 coupled to the electrolyte port 934 (not shown in FIG. 11, see FIG. 9B) of each zinc hydrogen cell 902 and a second manifold 1108 coupled to the gas vent port 916 (not shown in FIG. 11, see FIG. 9B) of each zinc hydrogen cell 902. The zinc hydrogen battery system 1102 may further include an electrolyte storage such as an electrolyte drum 1110. The electrolyte drum 1110 may be configured to hold at least twice the combined volume of the zinc hydrogen cells 902 in the zinc hydrogen battery 1104. For example, the electrolyte drum 1110 may be a 55 gallon drum. In an exemplary embodiment, the electrolyte drum 1110 may be filled with an electrolyte solution comprising 1-2% zincate in 30% potassium hydroxide. The zinc hydrogen battery system 1102 may further include a pump 1112. The electrolyte drum 1110 may be coupled to the second manifold 1108 and coupled to the first manifold 1106 through the pump 1112. The zinc hydrogen battery system 1102 may further include a gas line 1114 operably coupled to the second manifold 1108.

In an exemplary embodiment, the pump 1112 may operate to circulate the electrolyte solution from the electrolyte drum 1110 through the first manifold 1106, through the zinc hydrogen cells 902, through the second manifold 1108, and returned to the electrolyte drum 1110. The electrolyte solution may enter the zinc hydrogen cells 902 through the first manifold 1106, where the zincate may be plated as zinc metal on surfaces of the negative electrodes 922 (not shown in FIG. 11, see FIG. 9B), and depleted electrolyte may exit the zinc hydrogen cells 902 and return to the electrolyte drum 1110 via the second manifold 1108. Consequently, as the charge process proceeds, zincate concentration in the system decreases. As the zincate concentration nears complete depletion, the result is an increase in cell voltage, and charge termination may be triggered upon reaching an upper threshold of cell voltage. For example, in an exemplary embodiment, charge termination may be triggered when an individual zinc hydrogen cell 902 reaches 2.5 V. In an exemplary embodiment based on FIG. 11, the capacity is approximately 750 Ah (amp-hours) per zinc hydrogen cell 902, which upon subsequent discharge would deliver approximately 130 g of H₂, corresponding to an energy output of approximately 5100 Wh (watt-hours) of thermal energy based on the Higher Heating Value (HHV) of hydrogen. It should be appreciated that while the above embodiment contemplates a electrolyte flow from the first manifold 1106, through the zinc hydrogen cells 902, to the second manifold 1108; the reverse flow pattern, from the second manifold 1108, through the zinc hydrogen cells 902, to the first manifold 1106, could effectively achieve a similar result.

In an exemplary embodiment of a zinc hydrogen cell, cell voltage may be stable during the beginning and middle stages of the charge. Towards the end of the charge, in the absence of zinc bridging, the cell voltage may increase steadily as zincate in the electrolyte is slowly depleted. Accordingly, one trigger condition for terminating charge may be when an individual cell voltage reaches a threshold value signifying a fully charged cell.

Another trigger condition for terminating charge may related to formation of “bridging.” Even under conditions where dense zinc morphology predominates and high capacity is achieved, plated zinc may eventually physically bridge the positive electrode surface, causing an internal electrical short. The initial onset of bridging is typically not detrimental, with negligible self-discharge; however, continued charging may result in more substantial bridging, increasing self-discharge rates and degrading round-trip efficiency. Therefore, detection of the onset of bridging and timely charge cutoff may be helpful for optimized performance.

A zinc bridge may cause an internal electrical short, which may in turn cause a drop in cell voltage. This drop in cell voltage may be temporary and short-lived during onset as the zinc bridge transiently forms then detaches. These quick but discernable drops in cell voltage may be detectable and can be used in establishing a trigger condition to terminate charge of the cell before bridging can lead to larger, more substantial internal shorts.

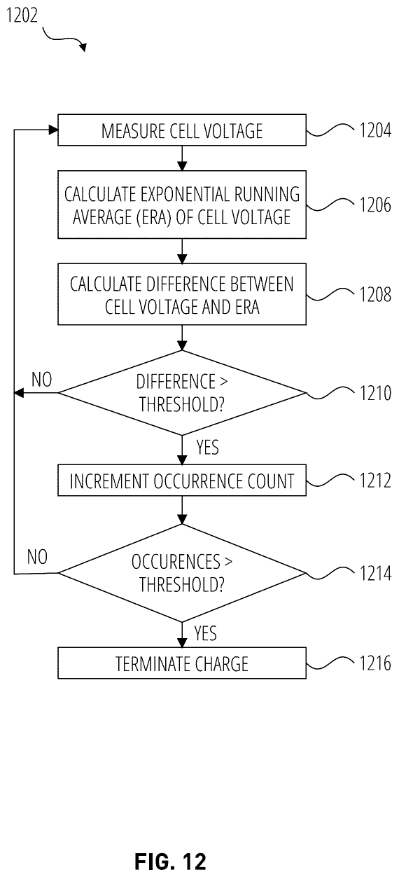

FIG. 12 shows an exemplary embodiment of a method 1202 for detecting the onset of zinc bridges and terminating a charge of a zinc hydrogen cell 902. The method 1202 may be implemented by a computer operably coupled to each zinc hydrogen cell 902 of the zinc hydrogen battery system 1102 shown in FIG. 11. In block 1204, a cell voltage of the zinc hydrogen cell 902 may be measured during a charge process, for example, using a voltmeter or other appropriate sensor. In block 1206, an exponential running average (ERA) of the cell voltage may be calculated based on the current measurement and past measurements. In an exemplary embodiment, the ERA of the cell voltage may be calculated in a way gives higher weight to recent data points and decreasing weight to older data points. In an exemplary embodiment, the ERA may be calculated according to the following formula:

ERA_{N}=(ERA_{N-1}*P)+(V_{N}*(1−P)) (5)
where N is an integer representing an iteration at which the ERA of the cell voltage is calculated, ERA_{N} is the ERA of the cell voltage at iteration N, i.e., the current iteration, ERA_{N-1} is the ERA of the cell voltage at iteration N−1, i.e., the previous iteration, Vx is the measured cell voltage at iteration N, and P is a weighting factor. In an exemplary embodiment, the weighting factor P may be 0.85. It will be understood that the calculation of the ERA and/or the weighting factor P may not be limited to this specific embodiment. For example, alternative equations for calculating the ERA and/or alternative values for the weighting factor P may be used.

In block 1208 a difference between the currently measured cell voltage and the ERA is calculated. This difference may be used to determine whether an “occurrence” has happened. In decision block 1210, it is evaluated whether the difference is greater than a predetermined voltage drop threshold. In an exemplary embodiment, the predetermined voltage drop threshold may be in a range of 20-200 mV. In an exemplary embodiment, the predetermined voltage drop threshold may be 80 mV. If the difference is not greater than the predetermined voltage drop threshold (i.e., “No” at decision block 1210), the method returns to block 1204. If the difference is greater than the predetermined voltage drop threshold (i.e., “Yes” at decision block 1210), then the difference is considered to be an “occurrence” and the method proceeds to block 1212.

In block 1212, a running counter of occurrences is incremented by 1. In decision block 1214, it is evaluated whether the running counter of occurrences is greater than a predetermined occurrence threshold. In an exemplary embodiment, the predetermined occurrence threshold is in a range of 2-20. In an exemplary embodiment, the predetermined occurrence threshold is 5. If the running counter is not greater than the predetermined occurrence threshold (i.e., “No” in decision block 1214), then the method returns to block 1204. If the running counter is greater than the predetermined occurrence threshold (i.e., “Yes” in 1214), then the method proceeds to block 1216. In 1216, charge of the zinc hydrogen cell 902 which has exceeded the occurrence threshold is terminated. The method 1202 described above may be applied independently to each zinc hydrogen cell 902 of the zinc hydrogen battery 1104, and charge and termination of charge may be independent controlled for each zinc hydrogen cell 902.

Overall, the synergy of the articles, apparatuses, and methods described above may help to minimize or eliminate detrimental dendritic zinc formation during the operation of a zinc hydrogen battery. A zinc hydrogen battery with negative electrodes having edges enclosed within an insulator and with an angle between the electrode and the insulator being less than or equal to 90 degrees may help to minimize dendritic zinc. Further, a charge process that defines the minimum applied current at a given zincate concentration based on the empirical equation (4) defined above may help to promote dense zinc morphology, thus minimizing dendritic zinc. A zinc hydrogen battery system that maximizes capacity at relatively low zincate concentration in the electrolyte may help to promote the conditions for dense zinc morphology during charge, thereby minimizing dendritic zinc formation. The electrolyte may be continuously pumped in from an external drum to meet a desired capacity at low zincate concentration. Furthermore, the charge termination method described above may help to detect the onset of zinc bridging during charge by reading voltage drops and triggering charge termination, thus minimizing detrimental internal shorts.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Approximating language, as used herein throughout the specification and claims, may be applied to modify any quantitative representation that could permissibly vary without resulting in a change in the basic function to which it is related. Accordingly, a value modified by a term such as “about” or “approximately” is not to be limited to the precise value specified. Such approximating language may refer to the specific value and/or may include a range of values that may have the same impact or effect as understood by persons of ordinary skill in the art field. For example, approximating language may include a range of +/−10%, +/−5%, or +/−3%. The term “substantially” as used herein is used in the common way understood by persons of skill in the art field with regard to patents, and may in some instances function as approximating language. In some instances, the approximating language may correspond to the precision of an instrument for measuring the value.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine”, “calculate,” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

1. A negative electrode assembly for use in a zinc hydrogen cell, the negative electrode assembly comprising:
a negative electrode formed in a substantially plate-shaped form, the negative electrode comprising:
a first surface; and
a first edge adjacent the first surface; and
an insulating material enclosing the first edge.

2. The negative electrode assembly of claim 1, wherein the insulating material comprises polypropylene, polyethylene, polyvinylchloride, or acrylonitrile butadiene styrene.

3. The negative electrode assembly of claim 1, wherein an angle between the first surface and the insulating material is less than or equal to 90 degrees.

4. The negative electrode assembly of claim 1, wherein the negative electrode comprises a material configured to reduce zincate to zinc metal and oxidize zinc metal to zincate reversibly.

5. The negative electrode assembly of claim 4, wherein the negative electrode comprises copper or copper foam.

6. The negative electrode assembly of claim 1, wherein:
the first edge is one of a plurality of edges; and
each edge of the plurality of edges is enclosed in the insulating material.

7. The negative electrode assembly of claim 6, wherein the plurality of edges further comprises:
a second edge adjacent to the first edge;
a third edge adjacent to the first edge and opposite the second edge; and
a fourth edge opposite to the first edge and adjacent to second edge and the third edge.

8. The negative electrode assembly of claim 6, wherein the insulating material comprises:
a first insulator sleeve enclosing the first edge;
a first electrode frame comprising a first slot for receiving and enclosing the second edge;
a second electrode frame comprising a second slot for receiving and enclosing the third edge; and
a second insulator sleeve enclosing the fourth edge.

9. A zinc hydrogen cell comprising:
a cell case defining a cell interior;
a plurality of negative electrodes provided within the cell interior;
a plurality of positive electrodes provided within the cell interior;
a negative terminal in electrical communication with the plurality of negative electrodes;
a positive terminal in electrical communication with the plurality of positive electrodes; and
an aqueous electrolyte comprising a reversible electro-active material disposed within the cell case;
wherein the plurality of negative electrodes and the plurality of positive electrodes are arranged in an alternating configuration with a gap between adjacent electrodes;
each negative electrode of the plurality of negative electrodes is formed in a substantially plate-shaped form and comprises:
a first surface; and
a first edge adjacent to the first surface;
wherein the first edge is enclosed within an insulating material.

10. The zinc hydrogen cell of claim 9, wherein the insulating material comprises polypropylene, polyethylene, polyvinylchloride, or acrylonitrile butadiene styrene.

11. The zinc hydrogen cell of claim 9, wherein an angle between the first surface and the insulating material is less than or equal to 90 degrees.

12. The zinc hydrogen cell of claim 9, wherein the negative electrode comprises a material configured to reduce zincate to zinc metal and oxidize zinc metal to zincate reversibly.

13. The zinc hydrogen cell of claim 12, wherein the negative electrode comprises copper or copper foam.

14. The zinc hydrogen cell of claim 9, further comprising:
a first electrode frame provided within the cell interior, the first electrode frame comprising a plurality of first slots formed in a first electrode frame surface;
a second electrode frame provided within the cell interior opposite to the first electrode frame, the second electrode frame comprising a plurality of second slots formed in a second electrode frame surface facing the first electrode frame surface;
wherein each negative electrode of the plurality of negative electrodes further comprises:
a second edge adjacent to the first edge;
a third edge adjacent to the first edge and opposite the second edge; and
a fourth edge opposite to the first edge and adjacent to second edge and the third edge;
wherein the insulating material comprises a first insulator sleeve enclosing the first edge;
the second edge is inserted into one of the plurality of first slots such that the first electrode frame encloses the second edge;
the third edge is inserted into one of the plurality of second slots such that the second electrode frame encloses the second edge; and
a second insulator sleeve encloses the fourth edge.

15. The zinc hydrogen cell of claim 9, wherein each positive electrode of the plurality of positive electrodes comprises a material configured to catalyze electrochemical formation of at least one of hydrogen gas and oxygen gas from an electrolyte.

16. The zinc hydrogen cell of claim 15, wherein each positive electrode of the plurality of positive electrodes comprises nickel or nickel foam.

17. The zinc hydrogen cell of claim 9, wherein the aqueous electrolyte comprises zincate saturated in potassium hydroxide or sodium hydroxide.

18. The zinc hydrogen cell of claim 17, wherein a concentration of the zincate in the bulk electrolyte is in a range of 0.1%-3% by weight.

19. The zinc hydrogen cell of claim 17, wherein the potassium hydroxide or sodium hydroxide has a concentration in a range of 5%-45% by weight in water.

20. A zinc hydrogen battery system comprising:
a plurality of zinc hydrogen cells, each zinc hydrogen cell of the plurality of zinc hydrogen cells comprising:
a cell case defining a cell interior;
a plurality of negative electrodes provided within the cell interior;
a plurality of positive electrodes provided within the cell interior;
a negative terminal in electrical communication with the plurality of negative electrodes;
a positive terminal in electrical communication with the plurality of positive electrodes;
an aqueous electrolyte comprising a reversible electro-active material disposed within the cell case;
an electrolyte port provided at a bottom of the cell case; and
a gas vent port provided at a top of the cell case;
wherein the plurality of negative electrodes and the plurality of positive electrodes are arranged in an alternating configuration with a gap between adjacent electrodes;
each negative electrode of the plurality of negative electrodes is formed in a substantially plate-shaped form and comprises:
a first surface; and
a first edge adjacent to the first surface;
wherein the first edge is enclosed within an insulating material;
a first manifold coupled to each electrolyte port of the plurality of zinc hydrogen cells;
a second manifold coupled to each gas vent port of the plurality of zinc hydrogen cells;
an electrolyte storage in fluid communication with the first manifold and the second manifold; and
a pump configured to circulate the aqueous electrolyte from the electrolyte storage, through the first manifold, through each zinc hydrogen cell of the plurality of zinc hydrogen cells, through the second manifold, and returning to the electrolyte storage.

21. The zinc hydrogen battery system of claim 20, wherein the insulating material comprises polypropylene, polyethylene, polyvinylchloride, or acrylonitrile butadiene styrene.

22. The zinc hydrogen battery system of claim 20, wherein an angle between the first surface and the insulating material is less than or equal to 90 degrees.

23. The zinc hydrogen battery system of claim 20, wherein the negative electrode comprises a material configured to reduce zincate to zinc metal and oxidize zinc metal to zincate reversibly.

24. The zinc hydrogen battery system of claim 23, wherein the negative electrode comprises copper or copper foam.

25. The zinc hydrogen battery system of claim 20, wherein each zinc hydrogen cell of the plurality of zinc hydrogen cells further comprises:
a first electrode frame provided within the cell interior, the first electrode frames comprising a plurality of first slots formed in a first electrode frame surface;
a second electrode frame provided within the cell interior opposite to the first electrode frame, the second electrode frame comprising a plurality of second slots formed in a second electrode frame surface facing the first electrode frame surface;
wherein each negative electrode of the plurality of negative electrodes further comprises:
a second edge adjacent to the first edge;
a third edge adjacent to the first edge and opposite the second edge; and
a fourth edge opposite to the first edge and adjacent to second edge and the third edge;
wherein the insulating material comprises a first insulator sleeve enclosing the first edge;
the second edge is inserted into one of the plurality of first slots such that the first electrode frame encloses the second edge;
the third edge is inserted into one of the plurality of second slots such that the second electrode frame encloses the second edge; and
a second insulator sleeve encloses the fourth edge.

26. The zinc hydrogen battery system of claim 20, wherein each positive electrode of the plurality of positive electrodes comprises a material configured to catalyze electrochemical formation of at least one of hydrogen gas and oxygen gas from an electrolyte.

27. The zinc hydrogen battery system of claim 26, wherein each positive electrode of the plurality of positive electrodes comprises nickel or nickel foam.

28. The zinc hydrogen battery system of claim 20, wherein the aqueous electrolyte comprises zincate saturated in potassium hydroxide or sodium hydroxide.

29. The zinc hydrogen battery system of claim 20, wherein a concentration of the zincate in the bulk electrolyte is in a range of 0.1%-3% by weight.

30. The zinc hydrogen battery system of claim 20, wherein the potassium hydroxide or sodium hydroxide has a concentration in a range of 5%-45% by weight in water.

31. The zinc hydrogen battery system of claim 20, wherein a volume of the electrolyte storage is greater than or equal to twice a sum of the volumes of each zinc hydrogen cell of the plurality of zinc hydrogen cells.

32. A method of charging a zinc hydrogen cell, the method comprising:
providing a zinc hydrogen cell comprising:
a cell case defining a cell interior;
a plurality of negative electrodes provided within the cell interior;
a plurality of positive electrodes provided within the cell interior;
a negative terminal in electrical communication with the plurality of negative electrodes;
a positive terminal in electrical communication with the plurality of positive electrodes; and
an aqueous electrolyte comprising a reversible electro-active material disposed within the cell case;
wherein the plurality of negative electrodes and the plurality of positive electrodes are arranged in an alternating configuration with a gap between adjacent electrodes;
each negative electrode of the plurality of negative electrodes is formed in a substantially plate-shaped form and comprises:
a first surface; and
a first edge adjacent to the first surface;
wherein the first edge is enclosed within an insulating material;
applying an applied current density that satisfies the equation:
i>0.42c+0.068;
where i is the applied current density in amps/inch² and c is a concentration of zincate in the aqueous electrolyte by weight percent.

33. The method of claim 32, wherein the insulating material comprises polypropylene, polyethylene, polyvinylchloride, or acrylonitrile butadiene styrene.

34. The method of claim 32, wherein an angle between the first surface and the insulating material is less than or equal to 90 degrees.

35. The method of claim 32, wherein the negative electrode comprises a material configured to reduce zincate to zinc metal and oxidize zinc metal to zincate reversibly.

36. The method of claim 35, wherein the negative electrode comprises copper or copper foam.

37. The method of claim 32, wherein the zinc hydrogen cell further comprises:
a first electrode frame provided within the cell interior, the first electrode frame comprising a plurality of first slots formed in a first electrode frame surface;
a second electrode frame provided within the cell interior opposite to the first electrode frame, the second electrode frame comprising a plurality of second slots formed in a second electrode frame surface facing the first electrode frame surface;
wherein each negative electrode of the plurality of negative electrodes further comprises:
a second edge adjacent to the first edge;
a third edge adjacent to the first edge and opposite the second edge; and
a fourth edge opposite to the first edge and adjacent to second edge and the third edge;
wherein the insulating material comprises a first insulator sleeve enclosing the first edge;
the second edge is inserted into one of the plurality of first slots such that the first electrode frame encloses the second edge;
the third edge is inserted into one of the plurality of second slots such that the second electrode frame encloses the second edge; and
a second insulator sleeve encloses the fourth edge.

38. The method of claim 32, wherein each positive electrode of the plurality of positive electrodes comprises a material configured to catalyze electrochemical formation of at least one of hydrogen gas and oxygen gas from an electrolyte.

39. The method of claim 38, wherein each positive electrode of the plurality of positive electrodes comprises nickel or nickel foam.

40. The method of claim 32, wherein the aqueous electrolyte comprises zincate saturated in potassium hydroxide or sodium hydroxide.

41. The method of claim 40, wherein a concentration of the zincate in the bulk electrolyte is in a range of 0.1%-3% by weight.

42. The method of claim 40, wherein the potassium hydroxide or sodium hydroxide has a concentration in a range of 5%-45% by weight in water.

43. The method of claim 32, further comprising:
providing an electrolyte storage in fluid communication with the cell interior, the electrolyte storage storing a volume of the aqueous electrolyte that is at least twice as large as a volume of the cell interior; and
circulating the aqueous electrolyte through the cell interior.

44. A method of terminating a charge process of a zinc hydrogen cell, the method comprising:
providing a zinc hydrogen cell comprising:
a cell case defining a cell interior;
a plurality of negative electrodes provided within the cell interior;
a plurality of positive electrodes provided within the cell interior;
a negative terminal in electrical communication with the plurality of negative electrodes;
a positive terminal in electrical communication with the plurality of positive electrodes; and
an aqueous electrolyte comprising a reversible electro-active material disposed within the cell case;
wherein the plurality of negative electrodes and the plurality of positive electrodes are arranged in an alternating configuration with a gap between adjacent electrodes;
each negative electrode of the plurality of negative electrodes is formed in a substantially plate-shaped form and comprises:
a first surface; and
a first edge adjacent to the first surface;
wherein the first edge is enclosed within an insulating material;
measuring a cell voltage of the zinc hydrogen cell;
calculating an exponential running average (ERA) of the cell voltage;
calculating a difference between the measured cell voltage and the ERA of the cell voltage;
comparing the difference to a predetermined voltage threshold;
in response to the difference being less than or equal to the predetermined threshold voltage, returning to the step of measuring the cell voltage; and
in response to the difference being greater than a predetermined voltage threshold, performing:
incrementing an occurrence count;
comparing the occurrence count to a predetermined occurrence threshold;
in response to the occurrence count being less than or equal to the predetermined occurrence threshold, returning to the step of measuring the cell voltage; and
in response to the occurrence count being greater than the predetermined occurrence threshold, terminating the charge process of the zinc hydrogen cell.

45. The method of claim 44, wherein the predetermined voltage threshold is in a range of 20 mV to 200 mV.

46. The method of claim 45, wherein the predetermined voltage threshold is 80 mV.

47. The method of claim 44, wherein the predetermined occurrence threshold is in a range of 2 to 20.

48. The method of claim 47, wherein the predetermined occurrence threshold is 5.

49. The method of claim 44, wherein the insulating material comprises polypropylene, polyethylene, polyvinylchloride, or acrylonitrile butadiene styrene.

50. The method of claim 44, wherein an angle between the first surface and the insulating material is less than or equal to 90 degrees.

51. The method of claim 44, wherein the negative electrode comprises a material configured to reduce zincate to zinc metal and oxidize zinc metal to zincate reversibly.

52. The method of claim 51, wherein the negative electrode comprises copper or copper foam.

53. The method of claim 44, wherein the zinc hydrogen cell further comprises:
a first electrode frame provided within the cell interior, the first electrode frame comprising a plurality of first slots formed in a first electrode frame surface;
a second electrode frame provided within the cell interior opposite to the first electrode frame, the second electrode frame comprising a plurality of second slots formed in a second electrode frame surface facing the first electrode frame surface;
wherein each negative electrode of the plurality of negative electrodes further comprises:
a second edge adjacent to the first edge;
a third edge adjacent to the first edge and opposite the second edge; and
a fourth edge opposite to the first edge and adjacent to second edge and the third edge;
wherein the insulating material comprises a first insulator sleeve enclosing the first edge;
the second edge is inserted into one of the plurality of first slots such that the first electrode frame encloses the second edge;
the third edge is inserted into one of the plurality of second slots such that the second electrode frame encloses the second edge; and
a second insulator sleeve encloses the fourth edge.

54. The method of claim 44, wherein each positive electrode of the plurality of positive electrodes comprises a material configured to catalyze electrochemical formation of at least one of hydrogen gas and oxygen gas from an electrolyte.

55. The method of claim 54, wherein each positive electrode of the plurality of positive electrodes comprises nickel or nickel foam.

56. The method of claim 44, wherein the aqueous electrolyte comprises zincate saturated in potassium hydroxide or sodium hydroxide.

57. The method of claim 56, wherein a concentration of the zincate in the bulk electrolyte is in a range of 0.1%-3% by weight.

58. The method of claim 56, wherein the potassium hydroxide or sodium hydroxide has a concentration in a range of 5%-45% by weight in water.

59. The method of claim 43, wherein:
the zinc hydrogen cell is one of a plurality of zinc hydrogen cells in a zinc hydrogen battery system; and
the circulating aqueous solution comprises circulating the aqueous solution through the cell interior of each zinc hydrogen cell of the plurality of zinc hydrogen cells.

60. The method of claim 44, wherein:
the zinc hydrogen cell is one of a plurality of zinc hydrogen cells in a zinc hydrogen battery system; and
the method is performed independently for each zinc hydrogen cell of the plurality of zinc hydrogen cells.
